(19) United States
(12) Patent Application Publication
(10) Pub. No.: US 2024/0205752 A1
(43) Pub. Date: Jun. 20, 2024

(54) TERMINAL AND COMMUNICATION METHOD

(71) Applicant: NTT DOCOMO, INC., Tokyo (JP)

(72) Inventors: Shohei Yoshioka, Chiyoda-ku, Tokyo (JP); Naoya Shibaike, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 18/554,839

(22) PCT Filed: Mar. 30, 2022
(86) PCT No.: PCT/JP2022/016107

§ 371 Date: Oct. 11, 2023

(30) Foreign Application Priority Data
Apr. 19, 2021 (JP) 2021-070674

(51) Int. Cl. H04W 28/26; H04W 72/02; H04W 76/28

(52) U.S. Cl. CPC H04W 28/26; H04W 72/02; H04W 76/28

(57) ABSTRACT

Provided is a terminal that includes: a receiving unit configured to receive a signal from another terminal in a resource pool in which partial sensing is configured and periodic reservation is enabled; a control unit configured to determine candidate resources for resource selection in the resource pool from a resource selection window, determine resources that correspond to the candidate resources and are sensing targets, and select resources that are available for use by identifying the candidate resources based on a sensing result of the resources that are sensing targets; and a transmission unit configured to perform transmission to the other terminal by using the selected resources. In a case where not all of the resources that are sensing targets can be monitored, the control unit performs a resource selection-related operation that is different from a resource selection-related operation that is performed in a case where all of the resources that are sensing targets can be monitored.

### TECHNICAL FIELD

The present invention relates to a terminal and a communication method in a wireless communication system.

### BACKGROUND ART

In LTE (Long Term Evolution) and LTE successor systems (for example, LTE-A (LTE-Advanced), NR (New Radio) (also referred to as 5G), etc.), a D2D (Device to Device) technology in which terminals communicate directly with each other without intervening base stations is being discussed (see, for example, Non-Patent Document 1).

D2D reduces the traffic between terminals and base stations and enables communication between terminals even when the base stations are unable to communicate in the event of a disaster or the like. Although 3GPP (3rd Generation Partnership Project) refers to D2D as “sidelink”, the term “D2D” is used more commonly and will be used in this specification. However, in the description of embodiments below, the term “sidelink” will also be used as needed.

D2D communication is broadly classified into D2D discovery, which is for discovering other terminals that are capable of and communicating, D2D communication (also referred to as “D2D direct communication”, “D2D communication”, “terminal-to-terminal direct communication”, “inter-terminal communication”, etc.), which is for allowing the terminals to communicate directly with each other. Hereinafter, D2D communication, D2D discovery, and so forth will be collectively referred to simply as “D2D”, unless otherwise specified. Also, signals that are transmitted and received in D2D will be referred to as “D2D signals”. Various use cases of V2X (Vehicle to Everything) services in NR are being discussed (see, for example, Non-Patent Document 2).

### RELATED ART DOCUMENTS

### Non-Patent Documents

[Non-Patent Document 1] 3GPP TS 38. 211 V16. 5. 0 (2021-03)

[Non-Patent Document 2] 3GPP TR 22. 886 V15. 1. 0 (2017-03)

### SUMMARY OF THE INVENTION

### Problem to be Solved by the Invention

Power saving is being discussed for an enhancement of NR sidelink. For example, in resource allocation mode 2 in which a terminal selects resources autonomously, the terminal performs partial sensing to sense the limited resources in a sensing window, and, based on the result of this, selects candidates for available resources from the resource selection window.

When the terminal performs resource selection autonomously based on periodic-based partial sensing targeting resources reserved a by resource reservation period field, the slots that can be monitored might be limited, depending on the terminal's operating status.

The present invention has been made in view of the foregoing and is intended to perform resource selection based on the situation of sensing in terminal-to-terminal direct communication.

### Means for Solving the Problem

According to the disclosed technique, a terminal is provided. The terminal includes: a receiving unit configured to receive a signal from another terminal in a resource pool in which partial sensing is configured and periodic reservation is enabled; a control unit configured to determine candidate resources for resource selection in the resource pool from a resource selection window, determine resources that correspond to the candidate resources and are sensing targets, and select resources that are available for use by identifying the candidate resources based on a sensing result of the resources that are sensing targets; and a transmission unit configured to perform transmission to the other terminal by using the selected resources. In a case where not all of the resources that are sensing targets can be monitored, the control unit performs a resource selection-related operation that is different from a resource selection-related operation that is performed in a case where all of the resources that are sensing targets can be monitored.

### Advantageous Effect of the Present Invention

According to the disclosed technique, in terminal-to-terminal direct communication, resource selection can be performed based on the situation of sensing.

### BRIEF DESCRIPTION OF THE DRAWINGS

FIG. 1 is a diagram illustrating V2X;

FIG. 2 is a diagram illustrating an example (1) of a transmission mode in V2X;

FIG. 3 is a diagram illustrating an example (2) of a transmission mode in V2X;

FIG. 4 is a diagram illustrating an example (3) of a transmission mode in V2X;

FIG. 5 is a diagram illustrating an example (4) of a transmission mode in V2X;

FIG. 6 is a diagram illustrating an example (5) of a transmission mode in V2X;

FIG. 7 is a diagram illustrating an example (1) of a communication type in V2X;

FIG. 8 is a diagram illustrating an example (2) of a communication type in V2X;

FIG. 9 is a diagram illustrating an example (3) of a communication type in V2X;

FIG. 10 is a sequence diagram illustrating an example (1) of operation in V2X;

FIG. 11 is a sequence diagram illustrating an example (2) of operation in V2X;

FIG. 12 is a sequence diagram illustrating an example (3) of operation in V2X;

FIG. 13 is a sequence diagram illustrating an example (4) of operation in V2X;

FIG. 14 is a diagram illustrating an example of sensing operation;

FIG. 15 is a flowchart illustrating an example of preemption operation;

FIG. 16 is a diagram illustrating an example of preemption operation;

FIG. 17 is a diagram illustrating an example of partial sensing operation;

FIG. 18 is a diagram illustrating an example (1) of partial sensing according to an embodiment of the present invention;

FIG. 19 is a diagram illustrating an example (2) of partial sensing according to an embodiment of the present invention;

FIG. 20 is a flowchart illustrating an example (1) of partial sensing according to an embodiment of the present invention;

FIG. 21 is a flowchart illustrating an example (2) of partial sensing according to an embodiment of the present invention;

FIG. 22 is a diagram illustrating an example of a functional configuration of a base station 10 according to an embodiment of the present invention;

FIG. 23 is a diagram illustrating an example of a functional configuration of a terminal 20 according to an embodiment of the present invention; and

FIG. 24 is a diagram illustrating an example of a hardware configuration of the base station 10 or the terminal 20 according to an embodiment of the present invention.

### EMBODIMENTS FOR CARRYING OUT THE INVENTION

Hereinafter, embodiments the of present invention will be described with reference to the accompanying drawings. Note that the embodiments described below are examples, and the embodiments to which the present invention is applied are not limited to the following embodiments.

In operating the wireless communication system according to the embodiments of the present invention, existing technologies are used as appropriate. However, the existing technology may, for example, be existing LTE, but is not limited to existing LTE. The term “LTE” as used herein shall also have a broad meaning including LTE-Advanced and successor systems of LTE-Advanced (for example, NR) or wireless LAN (Local Area Network), unless otherwise specified.

Also, in the embodiments of the present invention, the duplex scheme may be TDD (Time Division Duplex) scheme, FDD (Frequency Division Duplex) scheme, or other schemes (for example, flexible duplex scheme).

Also, in the embodiments of the present invention, when a wireless parameter or the like is “configured”, this may mean that a predetermined value is configured in advance (pre-configured), or that a wireless parameter is configured that is indicated by a base station 10 or a terminal 20.

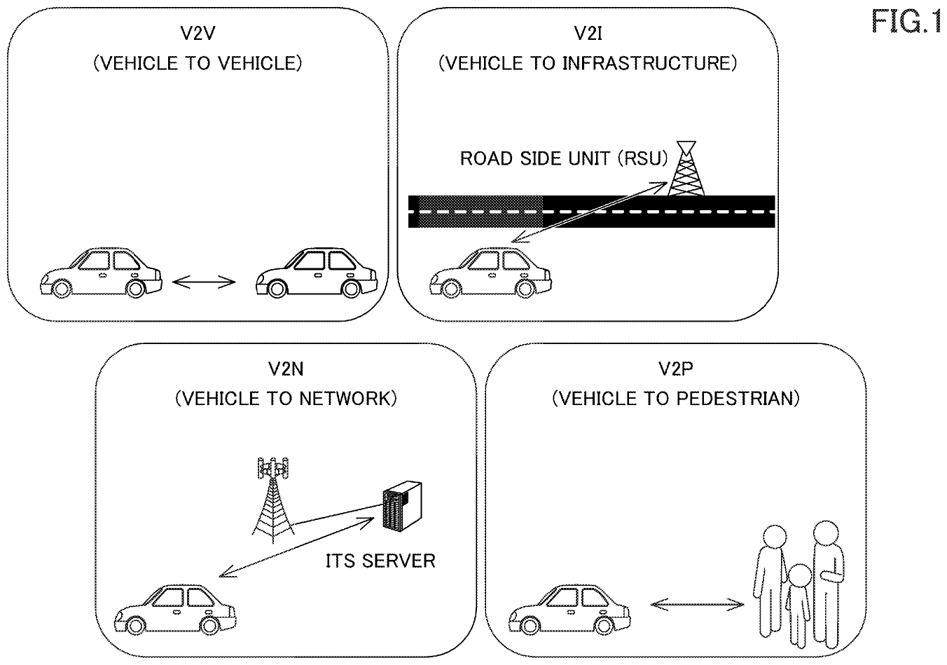

FIG. 1 is a diagram illustrating V2X. In 3GPP, implementing either V2X (Vehicle to Everything) or eV2X (enhanced V2X) by an enhancement of D2D function is being discussed, and its standardization is in progress. As illustrated in FIG. 1, V2X is a collective term for V2V (Vehicle to Vehicle), V2I (Vehicle to Infrastructure), V2N (Vehicle to Network), and V2P (Vehicle to Pedestrian). V2V is a part of ITS (Intelligent Transport Systems) and refers to a mode of communication between vehicles. V2I refers to a mode of communication between vehicles and roadside equipment (RSU: Road-Side Unit) that is installed on the roadside. V2N refers to a mode of communication between vehicles and ITS servers. V2P refers to a mode of communication between vehicles and mobile terminals that pedestrians carry with them.

In addition, V2X to use LTE or NR cellular communication and terminal-to-terminal communication is being discussed in 3GPP. V2X using cellular communication is also referred to as “cellular V2X”. In NR V2X, achieving large capacity, low delay, high reliability, and QoS (Quality of Service) control is being discussed.

It is expected that discussions regarding LTE-based or NR-based V2X will no longer be limited to 3GPP specifications in the future. For example, how to ensure interoperability, the reduction of cost by implementation of higher layers, the method of combining or switching between multiple RATs (Radio Access Technologies), regulatory compliance in each country, the method of acquiring and distributing data on LTE or NR V2X platform, the method of database management and use, and the like might become the subject of discussion.

In the embodiments of the present invention, it is primarily assumed that a communication device is mounted on a vehicle, but the embodiments of the present invention are not limited to such embodiments. For example, the communication device may be a terminal that a person carries with him/her, or the communication device may be a device mounted on a drone or an airplane, or the communication device may be a base station, an RSU, a relay station (relay node), a terminal having scheduling capability, and so forth.

Note that SL (Sidelink) may be distinguished from UL (Uplink) or DL (Downlink), based on one or a combination of following 1) to 4). Also, SL may be referred to by other names.
1) Resource allocation in the time domain
2) Resource allocation in the frequency domain
3) The synchronization signal that is referenced (including SLSS (SideLink Synchronization Signal)
4) The reference signal that is used to measure path loss for transmission power control

Also, regarding SL or UL OFDM (Orthogonal Frequency Division Multiplexing), either CP-OFDM (Cyclic-Prefix OFDM), DFT-S-OFDM (Discrete Fourier Transform-Spread-OFDM), OFDM without transform precoding, or OFDM with transform precoding may be employed.

In LTE SL, mode 3 and mode 4 are set forth in regard to the allocation of SL resources to the terminal 20. In mode 3, transmission resources are dynamically allocated by DCI (Downlink Control Information) that is transmitted from the base station 10 to the terminal 20. Also, in mode 3, SPS (Semi Persistent Scheduling) can be also performed. In mode 4, the terminal 20 autonomously selects transmission resources from a resource pool.

Note that a slot according to the embodiments of the present invention may be replaced by a symbol, a minislot, a subframe, a radio frame, and a TTI (Transmission Time Interval). Also, a cell according to the embodiments of the present invention may be replaced by a cell group, a carrier component, a BWP, a resource pool, a resource, an RAT (Radio Access Technology), a system (including wireless LAN), and the like.

According to the embodiments of the present invention, the terminal 20 is not limited to a V2X terminal, and may be any type of terminal that performs D2D communication. For example, the terminal 20 may be a terminal that a user carries with him/her, such as a smartphone, or an IOT (Internet of Things) device such as a smart meter.

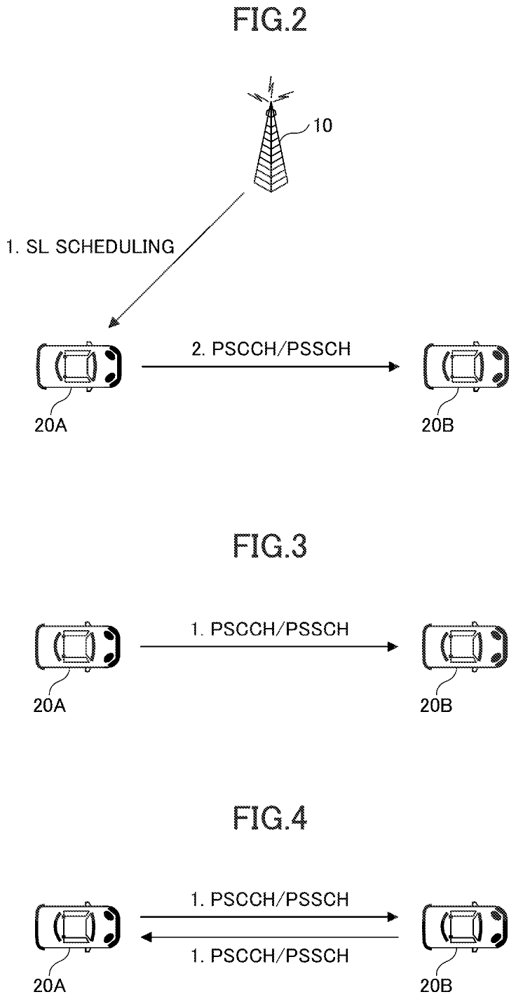

FIG. 2 is a diagram illustrating an example (1) of a transmission mode in V2X. In the sidelink communication transmission mode illustrated in FIG. 2, in step S1, the base station 10 transmits sidelink scheduling to a terminal 20A. Subsequently, the terminal 20A transmits a PSCCH (Physical Sidelink Control CHannel) and a PSSCH (Physical Sidelink Shared CHannel) to a terminal 20B based on the received scheduling (step S2). The transmission mode of sidelink communication illustrated in FIG. 2 may be referred to as “sidelink transmission mode 3 in LTE”. In sidelink transmission mode 3 in LTE, Uu-based sidelink scheduling is performed. Uu is a between wireless interface UTRAN (Universal Terrestrial Radio Network) and UE (User Equipment). Note that the transmission mode of sidelink communication illustrated in FIG. 2 may be referred to as “sidelink transmission mode 1 in NR”.

FIG. 3 is a diagram illustrating an example (2) of a transmission mode in V2X. In the sidelink communication transmission mode illustrated in FIG. 3, in step S1, the terminal 20A transmits a PSCCH and a PSSCH to the terminal 20B by using autonomously selected resources. The transmission mode of sidelink communication illustrated in FIG. 3 may be referred to as “sidelink transmission mode 4 in LTE”. In sidelink transmission mode 4 in LTE, the UE itself performs the resource selection.

FIG. 4 is a diagram illustrating an example (3) of a transmission mode in V2X. In the sidelink communication transmission mode illustrated in FIG. 4, in step S1, the terminal 20A transmits a PSCCH and a PSSCH to the terminal 20B by using autonomously selected resources. Similarly, the terminal 20B transmits a PSCCH and a PSSCH to the terminal 20A by using autonomously selected resources (step S1). The transmission mode of sidelink communication illustrated in FIG. 4 may be referred to as “sidelink transmission mode 2a in NR”. In sidelink transmission mode 2 in NR, the terminal 20 itself performs the resource selection.

FIG. 5 is a diagram illustrating an example (4) of a transmission mode in V2X. In the sidelink communication transmission mode illustrated in FIG. 5, in step 0, a sidelink resource pattern is transmitted from the base station 10 to the terminal 20A via RRC (Radio Resource Control) configuration, or configured in advance. Subsequently, the terminal 20A transmits a PSSCH to the terminal 20B based on that resource pattern (step 1). The transmission mode of sidelink communication illustrated in FIG. 5 may be referred to as “sidelink transmission mode 2c in NR”.

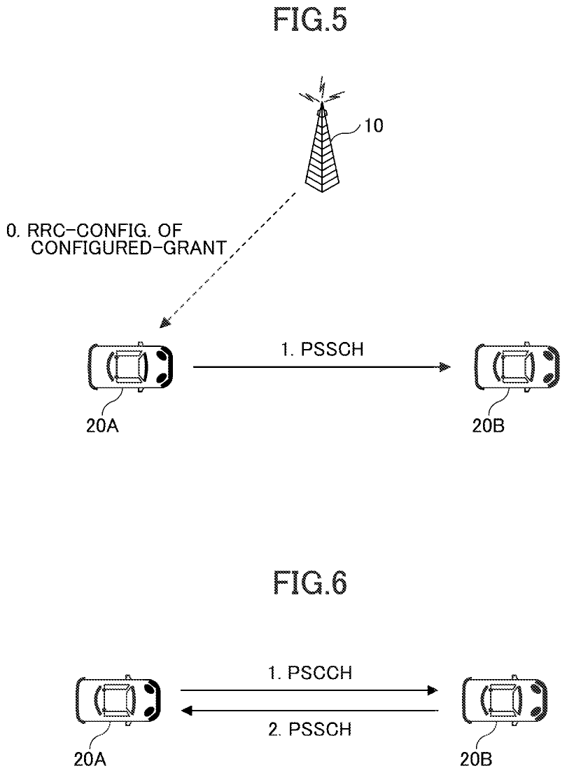

FIG. 6 is a diagram illustrating an example (5) of a transmission mode in V2X. In the sidelink communication transmission mode illustrated in FIG. 6, in step S1, the terminal 20A transmits sidelink scheduling to the terminal 20B via a PSCCH. Subsequently, the terminal 20B transmits a PSSCH to the terminal 20A based on the received scheduling (step 2). The transmission mode of sidelink communication illustrated in FIG. 6 may be referred to as “sidelink transmission mode 2d in NR”.

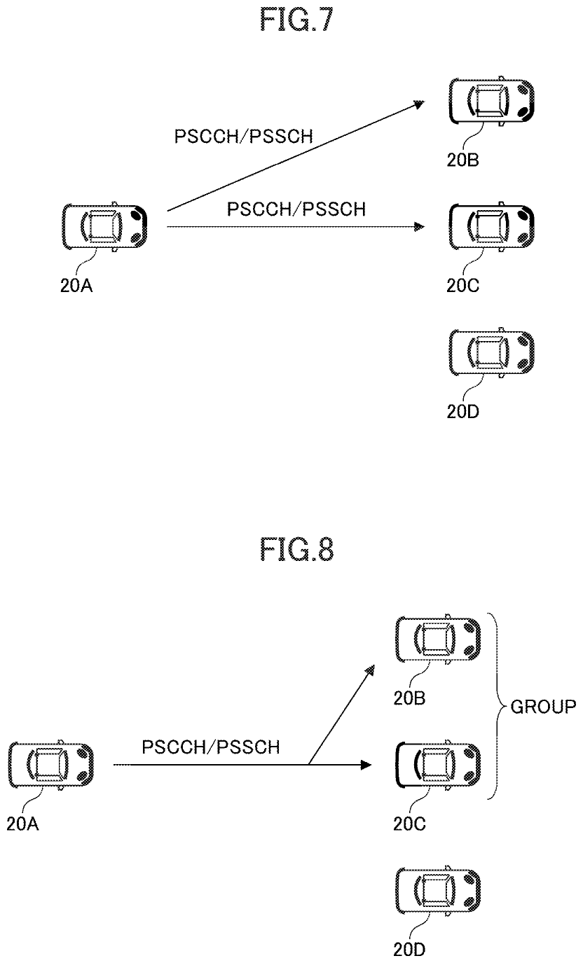

FIG. 7 is a diagram illustrating an example (1) of a communication type in V2X. The sidelink communication type illustrated in FIG. 7 is unicast. The terminal 20A transmits a PSCCH and a PSSCH to terminals 20. In the example illustrated in FIG. 7, the terminal 20A performs unicast to the terminal 20B and performs unicast to a terminal 20C.

FIG. 8 is a diagram illustrating an example (2) of a communication type in V2X. The sidelink communication type illustrated in FIG. 8 is groupcast. The terminal 20A transmits a PSCCH and a PSSCH to a group where one or more terminals 20 belong. In the example illustrated in FIG. 8, the group includes the terminal 20B and the terminal 20C, and the terminal 20A performs groupcast for this group.

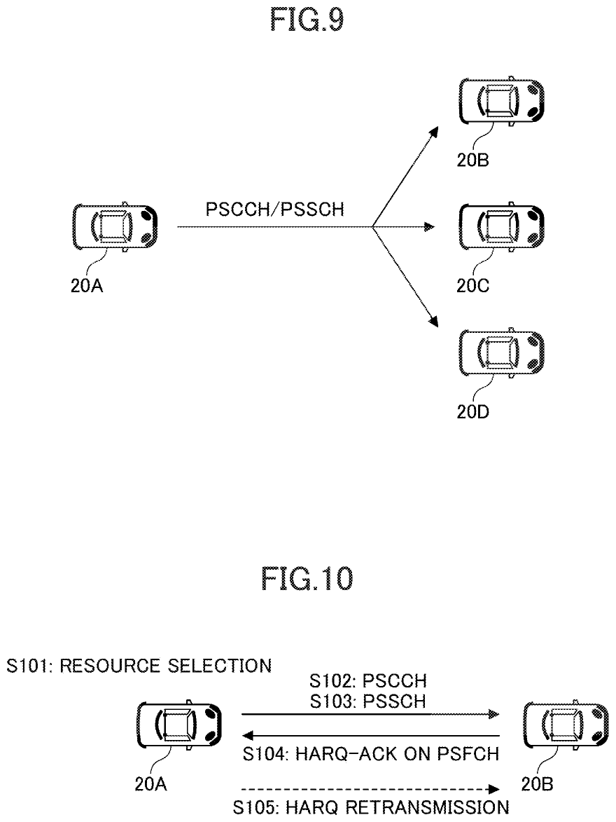

FIG. 9 is a diagram illustrating an example (3) of a communication type in V2X. The sidelink communication type illustrated in FIG. 9 is broadcast. The terminal 20A transmits a PSCCH and a PSSCH to one or more terminals 20. In the example illustrated in FIG. 9, the terminal 20A performs broadcast to the terminal 20B, the terminal 20C, and a terminal 20D. Note that the terminal 20A illustrated in FIG. 7 to FIG. 9 may be referred to as a “header UE”.

In addition, it is assumed that HARQ (Hybrid Automatic Repeat reQuest) is supported in sidelink unicast and groupcast in NR-V2X. In addition, SFCI (Sidelink Feedback Control Information) containing an HARQ response is defined in NR-V2X. In addition, transmission of SFCI via a PSFCH (Physical Sidelink Feedback CHannel) is being discussed.

Note that, in the following description, the PSFCH is used for the transmission of HARQ-ACK in sidelink, but this is an example. For example, the PSCCH may be used to transmit HARQ-ACK in sidelink, the PSSCH may be used to transmit HARQ-ACK in sidelink, or other channels may be used to transmit HARQ-ACK in sidelink.

Hereinafter, all information that the terminal 20 reports in HARQ will be collectively referred to as “HARQ-ACK” for ease of explanation. This HARQ-ACK may also be referred to as “HARQ-ACK information”. More specifically, the codebook that is applied to HARQ information reported from the terminal 20 to the base station 10 or the like will be referred to as the “HARQ-ACK codebook”. The HARQ-ACK codebook defines the bit string of HARQ-ACK information. Note that HARQ-ACK not only transmits ACK but also transmits NACK as well.

FIG. 10 is a sequence diagram illustrating an example (1) of operation in V2X. As illustrated in FIG. 10, the wireless communication system according to the embodiments of the present invention may include the terminal 20A and the terminal 20B. Note that, in practice, there are a number user equipment, but FIG. 10 illustrates the terminal 20A and the terminal 20B as an example.

Hereinafter, when the terminals 20A, 20B, and the like are not particularly distinguished, the term “terminal 20” or “user equipment” will be simply used. FIG. 10 illustrates, for example, a case where both the terminal 20A and the terminal 20B are within a cell's coverage, but the operation according to the embodiments of the present invention is applicable even when the terminal 20B is outside that coverage.

As mentioned earlier, in this embodiment, the terminal 20 is, for example, a device installed in a vehicle such as an automobile, and has a cellular communication function as a UE in LTE or NR and a sidelink function. The terminal 20 may be a conventional portable terminal (such as a smartphone). The terminal 20 may also be an RSU. The RSU may be a UE-type RSU having the function of a UE or a gNB-type RSU having the function of a base station device.

Note that the terminal 20 need not be a device with a single housing. For example, assuming that various sensors are distributed and provided in a vehicle, the terminal 20 may be a device to accommodate these sensors.

The details of the processing of sidelink transmission data by the terminal 20 are basically the same as in UL transmission in LTE or NR. For example, the terminal 20 generates complex-valued symbols by scrambling and modulating transmission data's codeword, maps these complex-valued symbols to one or two layers, and performs precoding. The precoded complex-valued symbols are then mapped to resource elements to generate a transmission signal (for example, a complex-valued time-domain SC-FDMA signal), which is then transmitted from each antenna port.

Note that the base station 10 has a cellular communication function as a base station in LTE or NR and a function of enabling communication of the terminal 20 according to the present embodiment (for example, resource pool configuration, resource allocation, etc.). The base station 10 may also be an RSU (gNB-type RSU).

In the wireless communication system according to the embodiments of the present invention, the signal waveform used by the terminal 20 in SL or UL may be OFDMA, SC-FDMA, or other signal waveforms.

In step S101, the terminal 20A autonomously selects the resources to use for the PSCCH and the PSSCH resource selection window having a predetermined duration. The resource selection window may be configured from the base station 10 to the terminal 20. Here, as for the predetermined duration of the resource selection window, the duration may be determined by conditions of terminal implementation such as processing time, packet maximum allowable delay time, and so forth, or may be determined in advance by the technical specification. The predetermined duration may be referred to as the “interval in the time domain”.

In step S102 and step S103, the terminal 20A transmits SCI (Sidelink Control Information) in the PSCCH and/or the PSSCH by using the resources selected autonomously in step S101, and transmits SL data in the PSSCH. For example, the terminal 20A may transmit the PSCCH by using frequency resources adjacent to the PSSCH's frequency resources, in the same time resources as at least a part of the PSSCH's time resources.

The terminal 20B receives the SCI (PSCCH and/or PSSCH) and the SL data (PSSCH) transmitted from the terminal 20A. The received SCI may include information about the PSFCH resource for the terminal 20B to transmit HARQ-ACK in response to the data reception. The terminal 20A may include information about the autonomously selected resources in the SCI and then perform transmission.

In step S104, the terminal 20B transmits HARQ-ACK in response to the received data, to the terminal 20A, by using the PSFCH resource determined from the received SCI.

In step S105, when the HARQ-ACK received in step S104 requests retransmission, that is, when NACK (Negative ACKnowledgment) is returned, the terminal 20A retransmits the PSCCH and the PSSCH to the terminal 20B. The terminal 20A may retransmit the PSCCH and the PSSCH by using autonomously selected resources.

Note that step S104 and step S105 need not be performed when HARQ control with HARQ feedback is not performed.

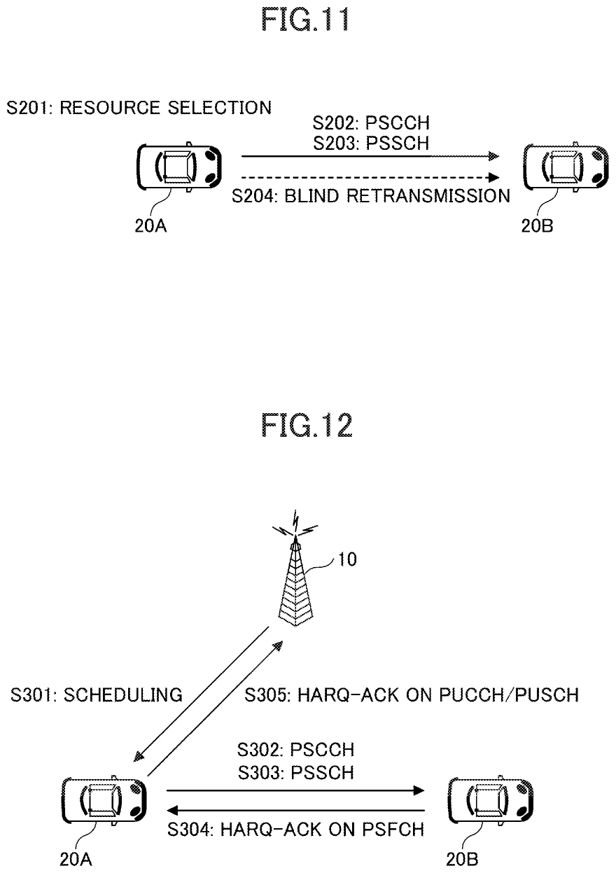

FIG. 11 is a sequence diagram illustrating an example (2) of operation in V2X. Blind retransmission, which is not based on HARQ control, may be performed here, for improved transmission success rate or reaching distance.

In step S201, the terminal 20A autonomously selects resources for use for the PSCCH and the PSSCH from a resource selection window having a predetermined duration. The resource selection window may be configured from the base station 10 to the terminal 20.

In step S202 and step S203, the terminal 20A transmits SCI in the PSCCH and/or the PSSCH and transmits SL data in the PSSCH using the resources selected autonomously in step S201. For example, the terminal 20A may transmit the PSCCH by using frequency resources adjacent to the PSSCH's frequency resources in the same time resources as at least a part of the PSSCH's time resources.

In step S204, the terminal 20A retransmits the SCI in the PSCCH and/or the PSSCH and the SL data in the PSSCH to the terminal 20B by using the resources selected autonomously in step S201. The retransmission in step S204 may be performed multiple times.

Note that step S204 need not be performed when blind retransmission is not performed.

FIG. 12 is a sequence diagram illustrating an example (3) of operation in V2X. The base station 10 may schedule sidelink. That is, the base station 10 may determine the sidelink resources to be used by the terminal 20, and transmit information to indicate these resources to the terminal 20. In addition, if HARQ control with HARQ feedback is employed, the base station 10 may transmit information indicative of PSFCH resources to the terminal 20.

In step S301, the base station 10 performs SL scheduling by transmitting DCI (Downlink Control Information) to the terminal 20A via the PDCCH. Hereinafter, for ease of explanation, DCI for SL scheduling will be referred to as “SL scheduling DCI”.

In step S301, it is also assumed that the base station 10 transmits DCI for DL scheduling (which may be referred to as “DL assignment”) to the terminal 20A on the PDCCH. Hereinafter, for ease of explanation, DCI for DL scheduling will be referred to as “DL scheduling DCI”. The terminal 20A configured to receive “DL scheduling DCI” receives DL data on the PDSCH by using resources specified by the DL scheduling DCI.

In step S302 and step S303, the terminal 20A transmits SCI (Sidelink Control Information) via the PSCCH and/or the PSSCH by using resources specified by SL scheduling DCI, and transmits the SL data via the PSSCH. Note that, in SL scheduling DCI, only the PSSCH's resources are specified. In this case, for example, the terminal 20A may transmit the PSCCH by using frequency resources adjacent to PSSCH frequency resources, in the same time resources as at least a part of the PSSCH's time resources.

The terminal 20B receives the SCI (PSCCH and/or PSSCH) and SL data (PSSCH) transmitted from the terminal 20A. The SCI received on the PSCCH and/or the PSSCH includes information related to the PSFCH resources for the terminal 20B to transmit HARQ-ACK in response to the receipt of data.

This resource information is included in the DL scheduling DCI or SL scheduling DCI transmitted from the base station 10 in step S301. The terminal 20A acquires this resource information from the DL scheduling DCI or SL scheduling DCI, and includes it in SCI. Alternatively, the DCI transmitted from the base station 10 does not include this resource information, and the terminal 20A may have to autonomously include this resource information in SCI and transmit this.

In step S304, the terminal 20B transmits HARQ-ACK for the received data to the terminal 20A by using PSFCH resources determined from the received SCI.

In step S305, the terminal 20A transmits HARQ-ACK by using PUCCH (Physical Uplink Control CHannel) resources designated by the DL scheduling DCI (or the SL scheduling DCI), for example, at a timing (for example, timing per slot) specified by the DL scheduling DCI (or the SL scheduling DCI). The base station 10 receives the HARQ-ACK. The HARQ-ACK codebook may include an HARQ-ACK received from the terminal 20B or an HARQ-ACK generated based on the PSFCH not received, and an HARQ-ACK in response to the DL data. However, no HARQ-ACK in response to the DL data is included if no DL data is assigned. In NR Rel. 16, the HARQ-ACK codebook includes no HARQ-ACK in response to DL data.

Note that step S304 and/or step S305 need not be performed when HARQ control with HARQ feedback is not performed.

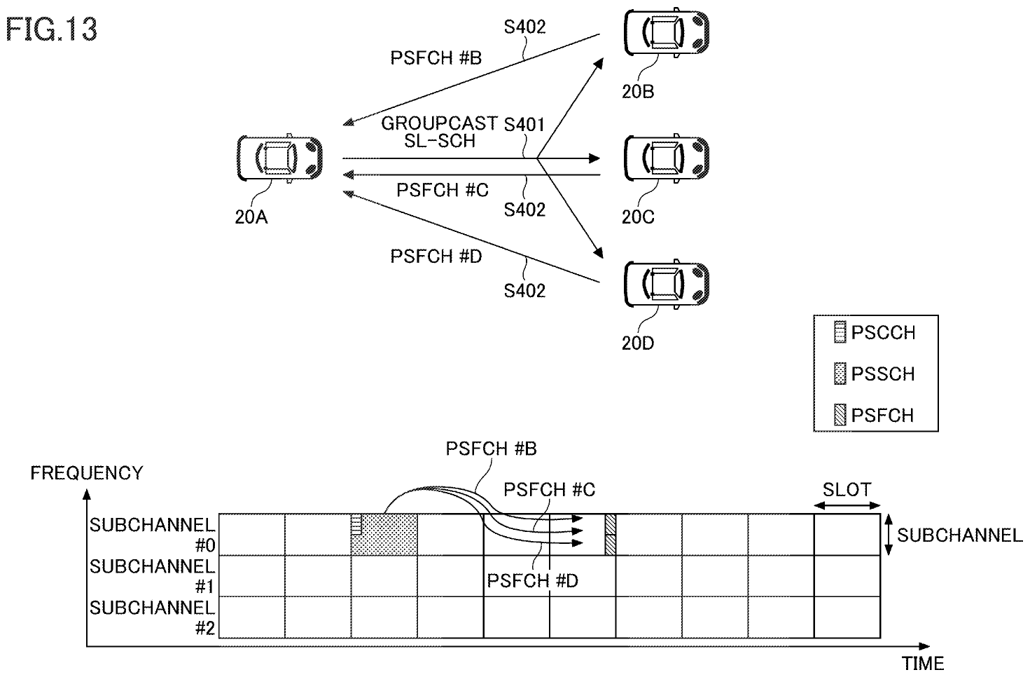

FIG. 13 is a sequence diagram illustrating an example (4) of operation in V2X. As mentioned earlier, NR sidelink supports transmission of HARQ response on the PSFCH. For example, the format of the PSFCH can be the same as that of PUCCH (Physical Uplink Control CHannel) format 0. That is, the PSFCH format may be a sequence-based format in which the PRB (Physical Resource Block) size is 1 and ACK and NACK are identified based on the difference in the sequence and/or the cyclic shift. The PSFCH format is not limited to this example. The PSFCH's resource may be located in the symbol or symbols at the end of the slot. Also, a period N for the PSFCH resources is configured or specified in advance. The period N may be configured or specified in advance based on a slot unit.

In FIG. 13, the vertical axis corresponds to the frequency domain, and the horizontal axis corresponds to the time domain. The PSCCH may be allocated to one symbol at the beginning of the slot, may be allocated to a plurality of symbols from the beginning of the slot, or may be allocated to a plurality of symbols apart from the symbols at the beginning. The PSFCH may be located in one symbol at the end of the slot or in multiple symbols at the end of the slot. In addition, the above “beginning of the slot” and “end of the slot” need not take into account the symbol for AGC (Automatic Gain Control) and the symbol for transmission/reception switching. That is, when, for example, one slot consists of 14 symbols, the “beginning” and the “end” of the slot may refer to the first and the last symbol of the 12 symbols, respectively, not including the first and last symbol of the 14 symbols. In the example illustrated in FIG. 13, three subchannels are configured in the resource pool, and two PSFCHs are placed in a slot that is located at the third slot after the slot in which a PSSCH is placed. The arrows from the PSSCH to the PSFCHs indicate examples of PSFCHs associated with a PSSCH.

In a case where the HARQ response in NR-V2X groupcast is groupcast option 2 for transmitting ACK or NACK, the resource used to transmit and receive PSFCH needs to be determined. As illustrated in FIG. 13, in step S401, the terminal 20A, which is the transmitting terminal 20, performs groupcast to the terminal 20B, the terminal 20C, and the terminal 20D, which are the receiving terminals 20, through SL-SCH. In subsequent step S402, the terminal 20B uses a PSFCH #B, the terminal 20C uses a PSFCH #C, and the terminal 20D uses a PSFCH #D to transmit HARQ response to the terminal 20A. Here, as illustrated in the example of FIG. 13, if the number of PSFCH resources that are available for use is less than the number of receiving terminals 20 belonging to the group, it is necessary to determine how to allocate the PSFCH resources. Note that the transmitting terminals 20 may identify the number of receiving terminals 20 in groupcast. In groupcast option 1, only NACK is transmitted as HARQ response, and no ACK is transmitted.

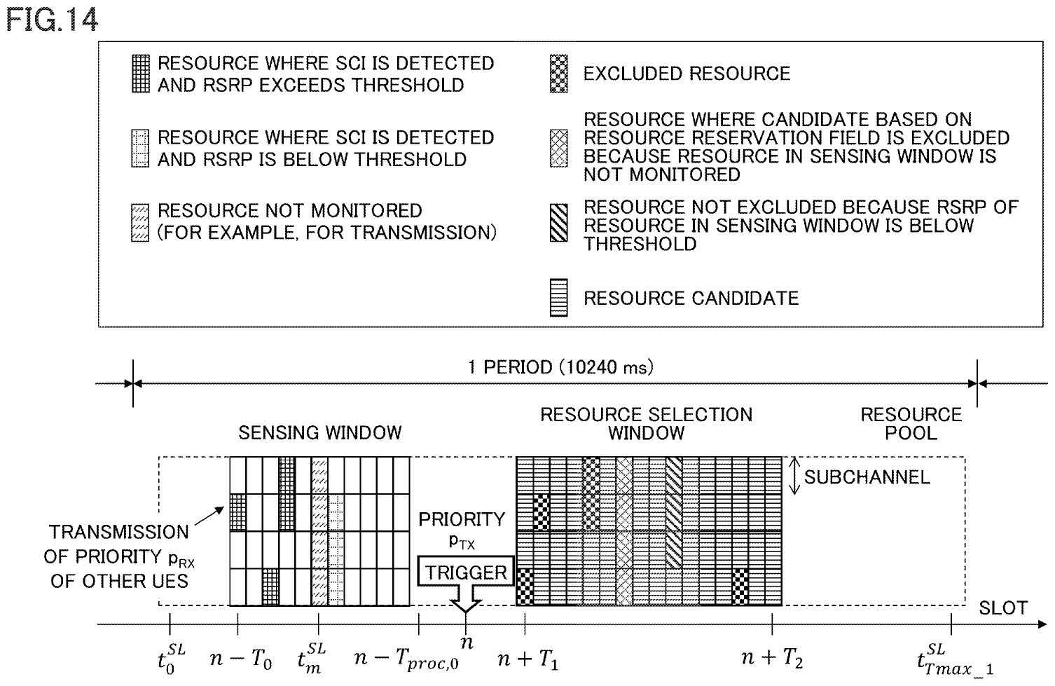

FIG. 14 is a diagram illustrating an example of sensing operation in NR. In resource allocation mode 2, the terminal 20 selects resources and transmits the selected resources. As illustrated in FIG. 14, the terminal 20 performs sensing in a sensing window in the resource pool. By means of this sensing, the terminal 20 receives the resource reservation field or the resource assignment field contained in the SCI transmitted from another terminal 20, and, based on that field, identifies available resource candidates in the resource selection window in the resource pool. Following this, the terminal 20 randomly selects resources from the available resource candidates.

Furthermore, the configuration of the resource pool may also have a period, as illustrated in FIG. 14. For example, the period may be a duration of 10240 milliseconds. FIG. 14 is an example in which a resource pool of slot t₀^{SL} to slot t_{Tmax-1}^{SL} is configured. An area of the resource pool in each period may be configured by, for example, a bitmap.

Furthermore, as illustrated in FIG. 14, the transmission trigger at the terminal 20 occurs in a slot n, and the priority of this transmission is p_{TX}. The terminal 20 can detect, for example, when another terminal 20 is carrying out a transmission of priority p_{RX} in the sensing window from a slot n-T₀ to the slot immediately preceding slot n-T_{proc, 0}. SCI is detected in the sensing window and the RSRP (Reference Signal Received Power) exceeds a threshold, the resources corresponding to this SCI in the resource selection window are excluded. Also, if SCI is detected in the sensing window and the RSRP is below the threshold, the resources in the resource selection window corresponding to that SCI are not excluded. This threshold may be, for example, Th_{pTX, pRX}, and configured or defined for each resource in the sensing window based on priority p_{TX} and priority p_{RX}.

In addition, as is the case with slot tₘ^{SL} illustrated in FIG. 14, resources in the resource selection window that are candidates for the resource reservation information corresponding to resources in the sensing window that have not been monitored for (due to) transmission, for example, are excluded.

With respect to the resource selection window from slot n+T₁ to slot n+T₂, as illustrated in FIG. 14, the resources occupied by the other UE are the resources excluding these identified, and resource become available resource candidates. When S_{A} represents a set of available resource candidates, in a case where S_{A} is less than 20% of the resource selection window, the resource identification may be performed again by increasing the threshold Th_{pTX, pRX} configured for each resource in the sensing window by 3 dB. That is, by performing the resource identification again by increasing the thresholds Th_{pTX, pRX}, the resources that are not excluded because the RSRP is below the threshold are increased so that the set S_{A} of resource candidates becomes 20% or more of the resource selection window. The operation of increasing the threshold Th_{pTX, pRX} configured for each resource in the sensing window by 3 dB and performing the resource identification again when S_{A} is less than 20% of the resource selection window may be repeated.

The lower layers of the terminal 20 may report S_{A} to the higher layers. The higher layers of the terminal 20 may perform random selection with respect to S_{A} and determine the resources to for use. The terminal 20 may perform sidelink transmission by using the determined resources.

Although FIG. 14 above illustrates the operation of the transmitting terminal 20, the receiving terminal 20 may sense data transmission from the other terminal 20 and receive data from the other terminal 20 based on the result of sensing or partial sensing.

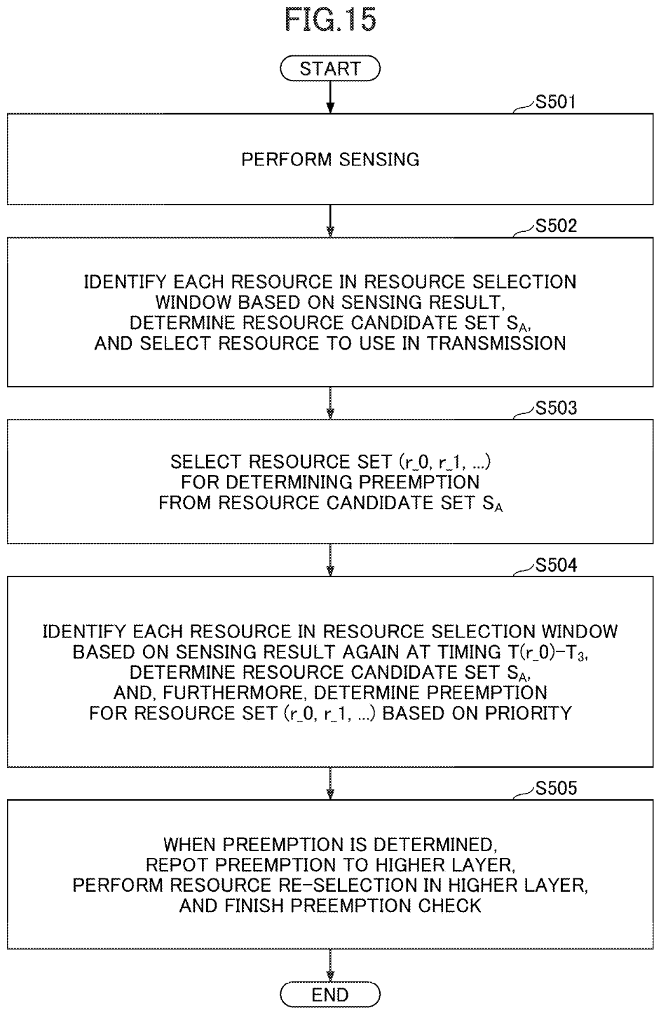

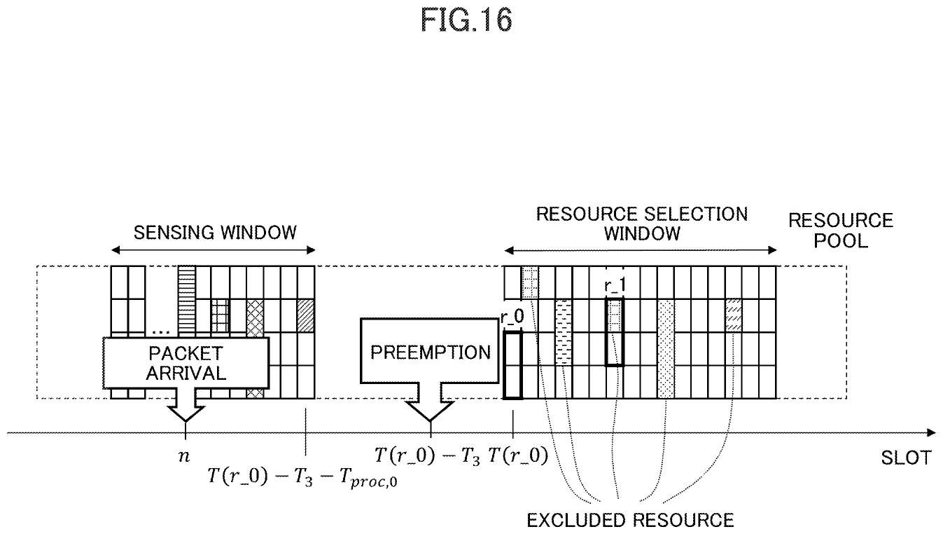

FIG. 15 is a flowchart illustrating an example of preemption in NR. FIG. 16 is a diagram illustrating an example of preemption in NR. In step S501, the terminal 20 performs sensing in the sensing window. The sensing may be performed in a limited duration when the terminal 20 performs power saving operations. Subsequently, the terminal 20 identifies each resource in the resource selection window based on the sensing result, determines set S_{A} of resource candidates, and selects the resources to use for transmission (S502). Subsequently, the terminal 20 selects the resource set (r_0, r_1, . . . ) for determining preemption from set S_{A} of resource candidates (S503). The resource set may be indicated from the higher layers to the PHY layer as resources for determining whether preemption has been performed.

In step S504, at the timing of T(r_0)-T3 illustrated in FIG. 16, the terminal 20 identifies each resource in the resource selection window again based on the sensing result and determines set S_{A} of resource candidates, and, furthermore, determines preemption with respect to the resource set (r_0, r_1, . . . ) based on the priority. For example, with respect to r_1 illustrated in FIG. 16, the SCI transmitted from the other terminal 20 is detected by repeated sensing, and r_1 is not included in S_{A}. When preemption is enabled and the value prio_RX representing the priority of the SCI transmitted from the other terminal 20 is lower than a value prio_TX, representing the priority of the transport block to be transmitted from the terminal 20 itself, the terminal 20 determines that resource r_1 has been preempted. Note that the priority is higher when the value to indicate the priority is lower. That is, when the value prio_RX representing the priority of the SCI transmitted from the other terminal 20 is higher than the value prio_TX representing the priority of the transport block to be transmitted from the terminal 20 itself, the terminal 20 does not exclude resource r_1 from S_{A}. Alternatively, if preemption is enabled only for a specific priority (for example, when sl-PreemptionEnable is one of pl1, pl2, . . . , and pl8), then this priority is referred to as prio_pre. At this time, when the value prio_RX representing the priority of the SCI transmitted from the other terminal 20 is lower than prio_pre, and the value prio_RX is lower than prio_TX representing the priority of the transport block transmitted from the terminal 20 itself, the terminal 20 determines that resource r_1 has been preempted.

In step S505, when preemption is determined in step S504, the terminal 20 indicates the preemption to the higher layers. The resources are re-selected in the higher layers, and the preemption check is finished.

Note that, when reevaluation is performed instead of preemption check, in step S504, after set S_{A} of resource candidates is determined and yet no resources of the resource set (r_0, r_1, . . . ) are included in S_{A}, these resources are not used and resource reselection is performed in the higher layers.

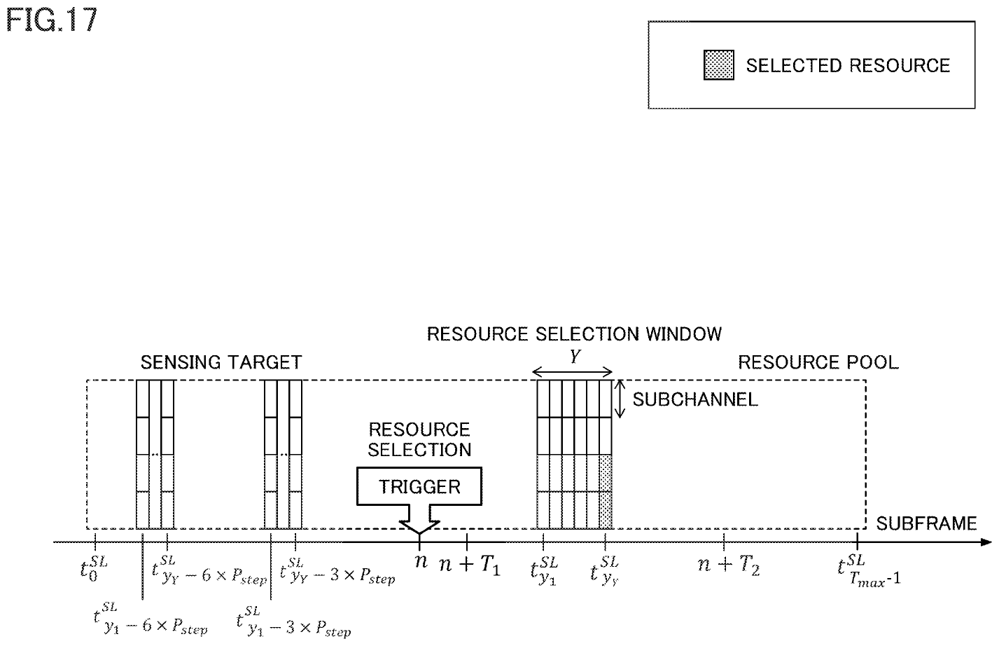

FIG. 17 is a diagram illustrating an example of partial sensing operation in LTE. When partial sensing is configured by the higher layers in LTE sidelink, the terminal 20 selects the resources and performs transmission, as illustrated in FIG. 17. As illustrated in FIG. 17, the terminal 20 performs partial sensing with respect to a part of the sensing window in the resource pool, that is, with respect to the sensing target. By means of this partial sensing, the terminal 20 receives the resource reservation field contained in the SCI transmitted from another terminal 20, and, based on that field, identifies the available resource candidates in the resource selection window in the resource pool. Subsequently, the terminal 20 randomly selects the resources from the available resource candidates.

FIG. 17 is an example in which subframes from a subframe t₀^{SL} to a subframe t_{Tmax-1}^{SL} are configured as a resource pool. With respect to the resource pool, a target area may be configured, for example, by bitmap. As illustrated in FIG. 17, the transmission trigger at the terminal 20 occurs in subframe n. As illustrated in FIG. 17, Y subframes, which range from subframe t_{y1}^{SL} to subframe t_{yY}^{SL}, among subframes from subframe n+T₁ to subframe n+T₂, may be configured as a resource selection window.

The terminal 20 may detect, for example, that another terminal 20 is performing transmission in one or more sensing targets from subframe t_{y1-k×Pstep}^{SL} to subframe t_{yY-k×Pstep}^{SL}, which are Y subframes long. k may be determined, for example, by using a 10-bit bitmap. FIG. 17 illustrates an example in which the third and sixth bits of the bitmap are configured to “1”, indicating that partial sensing is to be performed. That is, in FIG. 17, subframes from subframe t_{y1-6×Pstep}^{SL} to subframe t_{yY-6×Pstep}^{SL}, and subframes from subframe t_{y1-3×Pstep}^{SL} to subframe t_{yY-3×Pstep}^{SL} are configured as sensing targets. As noted earlier, the kth bit of the bitmap may correspond to a sensing window of subframe t_{y1-k×Pstep}^{SL} to subframe t_{yY-k×Pstep}^{SL}. Note that yᵢ corresponds to the index (1 . . . Y) in the Y subframes.

It should be noted that k may be configured or specified in advance by a bitmap of 10 bits, and Pₛₜₑₚ may be 100 ms. However, when SL communication is performed on DL and UL carriers, Pₛₜₑₚ may be (U/(D+S+U))*100 ms. U corresponds to the number of UL subframes, D corresponds to the number of DL subframes, and S corresponds to the number of special subframes.

If SCI is detected in the sensing target and the RSRP exceeds a threshold, the resources in the resource selection window corresponding to the resource reservation field of the SCI are excluded. Also, if SCI is detected in the sensing target and the RSRP is below the threshold, the resources in the resource selection window corresponding to the resource reservation field of the SCI are not excluded. The threshold may be, for example, Th_{pTX, pRX}, which is configured or defined for each resource in the sensing targets based on the transmitting priority p_{TX} and the receiving priority p_{RX}.

As illustrated in FIG. 17, in the resource selection window configured in the Y subframes in the interval [n+T₁, n+T₂], the terminal 20 identifies the resources occupied by the other UE, and the resources excluding the occupied resources become available resource candidates. Note that the Y subframes need not be contiguous. When S_{A} is a set of available resource candidates, in a case where S_{A} is less than 20% of the resources in the resource selection window, the threshold Th_{pTX, pRX} configured for each resource of the sensing targets may be increased by 3 dB and the resources are identified again.

That is, by increasing the thresholds Th_{pTX, pRX} and performing the resource identification again, resources that are not excluded because the RSRP is below the threshold may be increased. In addition, the RSSI of each resource in S_{A} may be measured and the resource with the lowest RSSI may be added to a set SB. The operation of adding the resource with the lowest RSSI in S_{A} to S_{B} may be repeated until the set SB of resource candidates becomes greater than 20% of the resource selection window.

The lower layers of the terminal 20 may report S_{B} to the higher layers. The higher layers of the terminal 20 may perform random selection with respect to S_{B} and determine the resources to use. The terminal 20 may perform sidelink transmission by using the determined resources. Note that, once the terminal 20 determines the resources, the terminal 20 may use the resources for a predetermined number of times (for example, Cᵣₑₛₑₗ times), periodically, without performing sensing.

Here, power saving based on random resource selection and partial sensing is being discussed in NR release 17 sidelink. For example, for power saving, random resource selection and partial sensing of sidelink in LTE release 14 may be applied to NR release 16 sidelink resource allocation mode 2. The terminal 20, to which partial sensing is applied, performs reception and sensing only in specific slots in the sensing window.

In addition, eURLLC (enhanced Ultra Reliable Low Latency Communication) is being discussed in NR release 17 sidelink, with inter-UE coordination as a baseline. For example, the terminal 20A may share information indicating a resource set with the terminal 20B, and the terminal 20B may take this information into account when performing resource selection for transmission.

For example, as a method of resource allocation in sidelink, the terminal 20 may perform full sensing as illustrated in FIG. 14. Also, the terminal 20 may perform partial sensing, in which the terminal 20 identifies resources based on sensing targeting only limited resources, unlike full sensing, and selects resources from the identified resource set. Furthermore, the terminal 20 may make the resources in the resource selection window the identified resource set, without excluding resources from the resources in the resource selection window, and perform random selection to select resources from the identified resource set.

Note that the method of performing random selection at the time of resource selection and using sensing information at the time of reevaluation or preemption check may be used as partial sensing or as random selection.

Regarding the operation of sensing, 1) and 2) shown below may be applied.

### 1) Periodic-Based Partial Sensing

The operation of determining sensing slots based on the period of reservation (reservation periodicity) in a scheme where only some of the slots are sensed. Note that the reservation periodicity is a value related to the resource reservation period field. Note that “period” and “periodicity” may be used interchangeably herein.

### 2) Contiguous Partial Sensing

The operation of determining sensing slots based on aperiodic reservation in a scheme where only some of the slots are sensed. Note that aperiodic reservation is a value related to the time resource assignment field.

In release 17, the operation may be specified assuming that there are three types of terminals 20. One is type A, and the type A terminal 20 does not have the ability to receive any sidelink signals and channels. However, the type A terminal 20 may receive the PSFCH and S-SSB as an exception.

Another one is type B, and the type B terminal 20 does not have the ability to receive any sidelink signals and channels except for the PSFCH and the S-SSB.

Yet another one is type D, and the type D terminal 20 has the ability to receive all the sidelink signals and channels that are defined in release 16. However, the type D terminal 20 does not exclude receiving of some sidelink signals and channels.

It should be noted that UE types other than type A, type B, and type D described above may be assumed, and the UE type need not be associated with the UE capability.

In addition, in release 17, multiple resource allocation methods may be configured for a given resource pool. In addition, SL-DRX (Discontinuous Reception) is supported as one of the power saving functions. That is, the receiving operation is performed only in a predetermined time interval.

As mentioned earlier, partial sensing is supported as one of the power saving functions. In a resource pool where partial sensing is configured and periodic reservation is enabled, the terminal 20 may perform periodic-based partial sensing as described above. Periodic reservation may mean reservation for sending other transport blocks. The terminal 20 may receive, from the base station 10, information for configuring a resource pool in which partial sensing is configured and periodic reservation is enabled.

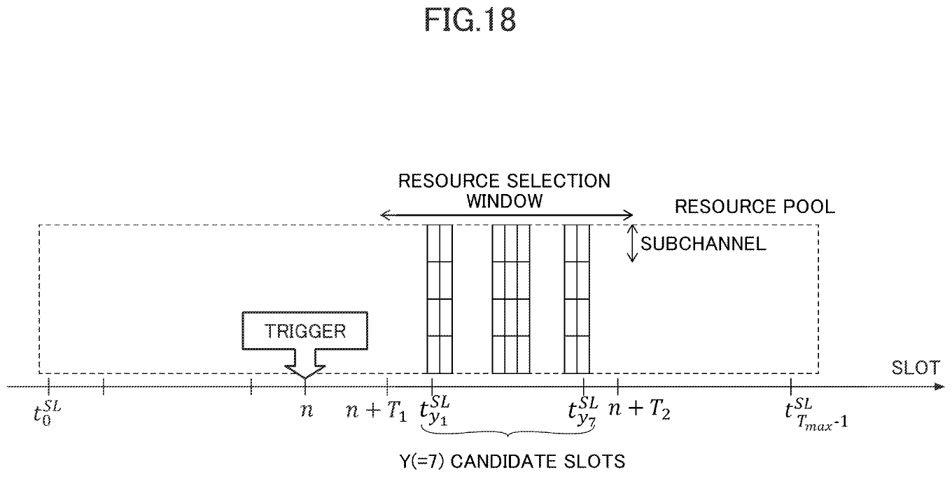

FIG. 18 is a diagram illustrating an example (1) of partial sensing according to an embodiment of the present invention. As illustrated in FIG. 18, when a trigger for resource selection occurs in slot n, the terminal 20 selects Y candidate slots for resource selection out of a resource selection window [n+T1, n+T2]. FIG. 18 is an example in the case of Y=7. As illustrated in FIG. 18, the beginning of Y candidate slots is slot t^{SL}_{y1}, the next slot is t^{SL}_{y2}, the next slot is t^{SL}_{y3}, the next slot is t^{SL}_{y4}, the next slot is t^{SL}_{y5}, the next slot is t^{SL}_{y6}, and the end is slot t^{SL}_{y7}.

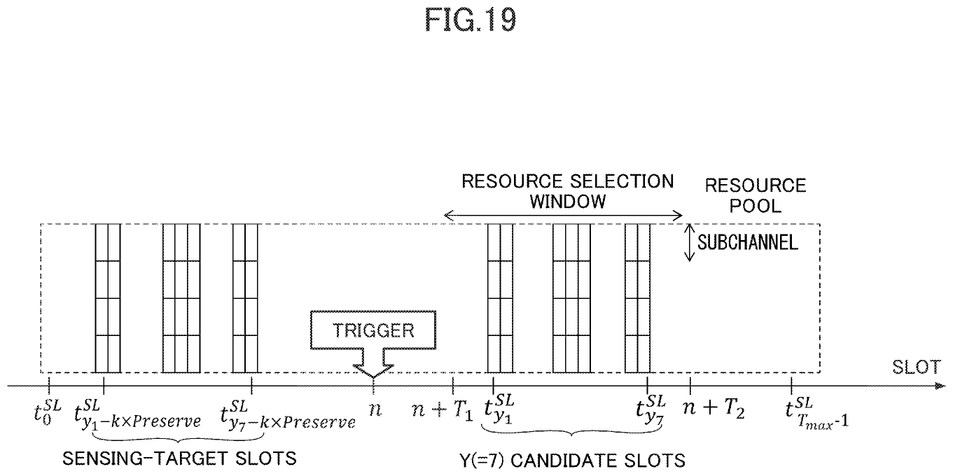

FIG. 19 is a diagram illustrating an example (2) of partial sensing according to an embodiment of the present invention. The terminal 20 may make t^{SL}_{y k×Preserve} shown in FIG. 19 the target slots for periodic-based partial sensing and perform the sensing. Note that t^{SL}_{y} is included in the Y candidate slots. That is, in the example illustrated in FIG. 19, sensing target slots from t^{SL}_{y1-k×Preserve} to t^{SL}_{y7-k×Preserve} are configured, which correspond to t^{SL}_{y1} to t^{SL}_{y7}. Pᵣₑₛₑᵣᵥₑ may have a periodic value that relates to the periodicity in which resource reservation can be performed, and which is allowed in this resource pool. Also, Pᵣₑₛₑᵣᵥₑ may be determined based on a higher layer parameter sl-ResourceReservePeriodList. Note that FIG. 19 illustrates a case where k has one value, and, in the event multiple k's are configured, the sensing target slots may be increased per k.

k in t^{SL}_{y-k×Preserve} may be configured as following 1)-7):
1) One k that corresponds only to the most recent sensing occasion for the configured reservation periodicity with respect to the time point before the resource selection trigger or the Y candidate slots. Note that the sensing occasion may be determined by taking into account the processing time restriction. For example, the sensing occasion may be located at the time point before the processing time restriction. Also, the processing time restriction may be a restriction related to the resource selection trigger, or may be a restriction related to the Y candidate slots.
2) Two k's that correspond to the two most recent sensing occasions for the configured reservation periodicity with respect to the time point before the resource selection trigger or the Y candidate slots. Note that the sensing occasions may be determined by taking into account the processing time restriction. For example, the sensing occasions may be located at the time point before the processing time restriction. Also, the processing time restriction may be a restriction related to the resource selection trigger, or may be a restriction related to the Y candidate slots.
3) All sensing occasions including the top of the sensing window, n-T₀, and thereafter. For example, T₀ may be determined by a higher layer parameter sl-SensingWindow.
4) Only one periodic sensing occasion for one reservation periodicity. k may be determined based on UE implementation, and the maximum value may be specified or configured.
5) One or more k's may be configured.
6) As in partial sensing in LTE-V2X illustrated in FIG. 17, a bitmap corresponding to the value of k is configured. The bitmap may be 10 bits long, for example, and the sensing occasions that are sensing targets are indicated by “1”, and the sensing occasions that are not sensing targets are indicated by “0”.
7) k may be determined by other methods.

Now, when the terminal performs resource selection autonomously based on partial sensing, the terminal needs to perform resource exclusion based on sensing in order to avoid resource collision, and also needs to save power by reducing the sensing targets. Therefore, it is desirable for the terminal to be enabled to configure the sensing target flexibly depending on the situation.

Therefore, the terminal 20 may determine the sensing target as shown in A) to D) below:
A) t^{SL}_{y-k×Preserve} based on K k's corresponding to the most recent K sensing occasions for the configured reservation periodicity with respect to the time point before the processing time restriction for the resource selection trigger or before the processing time restriction for Y candidate slots may be made the sensing targets. The value of K may be configured or specified in advance. Also, the value of K may be determined based on the priority, or may be determined based on the reservation periodicity associated with the data to be transmitted.
B) At least one of the methods of configuring k shown in 1) to 6) may be made a candidate for the method of configuring k, and one method of configuring k may be selected from the candidates based on the configuration or the priority.
C) Among above 1) to 6), above A), and above D), different methods of configuring k may be applied per configured periodicity. For example, above 2) may be applied when the periodicity is less than or equal to a predetermined value, and above 1) may be applied when the periodicity is greater than or equal to a predetermined value.
D) In 5) or 6) above, k may be configured to include the most recent sensing occasion. The most recent sensing occasion is the most recent sensing occasion for the configured reservation periodicity at the time point before the resource selection trigger or Y candidate slots. Note that the sensing occasion may be determined by taking into account the processing time restriction. For example, the sensing occasion may be located before the processing time restriction. Also, the processing time restriction may be a restriction related to the resource selection trigger, or may be a restriction related to the Y candidate slots.

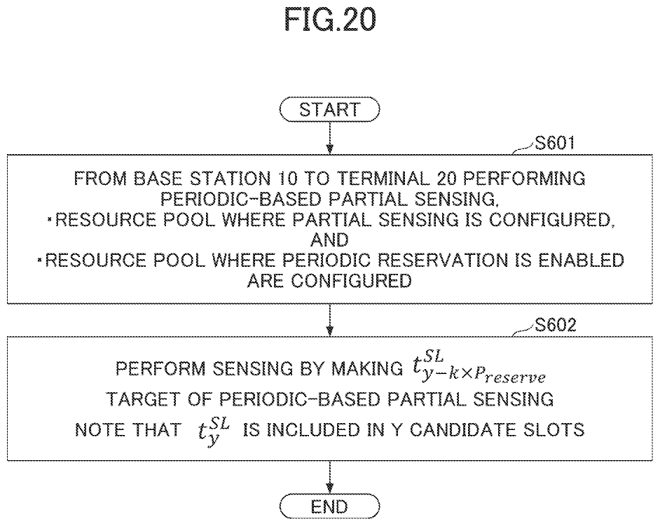

FIG. 20 is a flowchart illustrating an example (1) of partial sensing according to an embodiment of the present invention. In step S601, in the terminal 20, which performs periodic-based partial sensing, a resource pool in which partial sensing is configured and a resource pool in which periodic reservation is enabled are configured by the base station 10. In subsequent step S602, the terminal 20 performs sensing by making t^{SL}_{y-k×Preserve} the targets of periodic-based partial sensing. With respect to the above, t^{SL}_{y} is included in the Y candidate slots.

The terminal 20 may determine t^{SL}_{y-k×Preserve} as shown in 1) to 7) above or A) to D) above, and perform partial sensing. After performing resource exclusion in the Y candidate slots, the terminal 20 may select resources and perform sidelink transmission to other terminals 20.

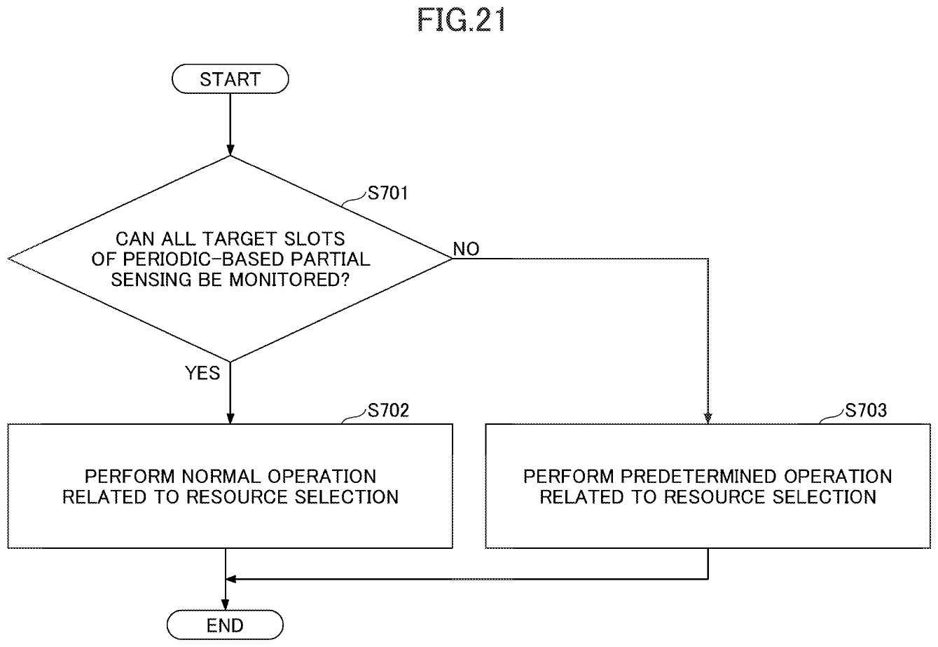

FIG. 21 is a flowchart illustrating an example (2) of partial sensing according to an embodiment of the present invention. In step S701, the terminal 20 determines whether all slots that are periodic-based partial sensing targets can be monitored. In a case where all slots that are periodic-based partial sensing targets can be monitored (YES in S701), the process proceeds to step S702. In a case where not all slots that are periodic-based partial sensing targets can be monitored (NO in S701), the process proceeds to step S703. Note that the case in which not all slots that are periodic-based partial sensing targets can be monitored may mean a case in which at least some of the slots that are periodic-based partial sensing targets are not monitored, or may mean a case in which condition 1) to condition 4) shown below are satisfied.

Condition 1) A case in which a slot that is a periodic-based partial sensing target is included in DRX inactive time.

Condition 2) A case in which the transmission traffic is aperiodic traffic. For example, this may be a case of traffic in which a parameter P_{rsvp_TX}, which indicates the resource reservation interval, is zero.

Condition 3) A case in which the transmission traffic is periodic traffic and is at the beginning of periodic transmission. For example, this may be a case of traffic in which the parameter P_{rsvp_TX}, which indicates the resource reservation interval, is non-zero.

Condition 4) A case in which the terminal 20 is performing transmission in slots that are periodic-based partial sensing targets.

In step S702, the terminal 20 performs normal operation related to resource selection. For example, the terminal 20 may perform periodic-based partial sensing as illustrated in FIG. 20, and perform resource selection based on the result of this periodic-based partial sensing.

On the other hand, in step S703, the terminal 20 performs a predetermined operation related to resource selection. The predetermined operation in step S703 may be operation a) to operation k) shown below:

### Operation a)

Periodic-based partial sensing need not be applied in a case where not all slots that are potential monitoring targets are monitored.

### Operation b)

The terminal 20 may perform resource identification by applying only contiguous partial sensing. By performing operation b), it becomes possible to take aperiodic reservation alone into consideration, which then makes it possible to avoid excluding resources based on insufficient information.

### Operation c)

The terminal 20 may perform resource selection by random selection, or may perform reevaluation or preemption check after random selection. Also, the terminal 20 does not have to perform resource identification. By performing operation c), collisions can be avoided based on reevaluation or preemption check, without performing resource identification based on insufficient information.

### Operation d)

The terminal 20 does not have to perform resource selection until a predetermined condition is met. For example, the predetermined condition may be that all slots that are monitoring targets in periodic-based partial sensing be monitored. For example, the predetermined condition may be that a predetermined amount and/or a predetermined ratio of slots of the slots that are monitoring targets in periodic-based partial sensing be monitored. Also, for example, the terminal 20 may drop transmission or postpone the transmission in a case where the predetermined condition is not met. For example, in a case where the predetermined condition is not met, the terminal 20 may update the Y candidate slots. The terminal 20 may determine that the predetermined condition is satisfied when all the slots that are monitoring targets are monitored in periodic-based partial sensing corresponding to the updated Y candidate slots. By performing operation d), it becomes possible to perform resource exclusion based on sufficient sensing information, and to prevent decreased reliability.

### Operation e)

Given the slots (X slots) that are monitoring targets in periodic-based partial sensing, the terminal 20 may apply different operations based on the slots (Y slots) whose sensing information the terminal 20 has. For example, the terminal 20 may change the operation based on whether, for example, Y is greater than or equal to j×X or Y exceeds j×X. j may be a parameter configured or defined as 0<j<1, or different values may be configured or defined depending on the priority or the PDB (Packet Delay Budget) of the transport block to be transmitted. In a case where Y is greater than or equal to j×X or Y exceeds j×X, the terminal 20 may perform resource exclusion in periodic-based partial sensing based on this sensing information. In a case where Y is less than or equal to j×X or Y is below j×X, the terminal 20 may perform contiguous partial sensing. By performing operation e), it becomes possible to appropriately control the criteria for determining whether or not there is sufficient sensing information, based on the required performance level.

### Operation f)

The terminal 20 may perform resource exclusion and/or resource identification operations that are different from those in a case where there is sensing information of all slots that are monitoring targets in periodic-based partial sensing. For example, the terminal 20 may make unmonitored slots targets of resource exclusion. For example, the terminal 20 may use different values for the RSRP threshold for resource exclusion. For example, the terminal 20 may apply different values to a parameter related to the amount of resources in identified resource set S_{A} (for example, the value configured in sl-TxPercentageList). By performing operation f), it becomes possible to prevent errors in the resource exclusion or resource identification operation from occurring due to lack of necessary sensing information.

### Operation g)

The terminal 20 may perform different operations depending on above condition 1) to above condition 4). For example, the terminal 20 may employ above d) in a case of above condition 3). For example, the terminal 20 may employ above b) in a case of above condition 2). By performing operation g), the terminal 20 can operate in an optimal way based on the reason the sensing target cannot be monitored.

### Operation h)

The terminal 20 may perform different operations depending on the case of resource selection or the case of reevaluation or preemption check. For example, operation d) may be performed in the case of resource selection, or operation b) may be performed in the case of reevaluation or preemption check. By performing operation h), sufficient resource exclusion can be performed as one aspect, and the number of slots to be monitored can be reduced as another aspect.

### Operation i)

The terminal 20 may determine which of operation a) to operation h) is to be performed based on at least one of 1) to 4) shown below:
1) Channel congestion: For example, CR (Channel occupancy Ratio), CBR (Channel Busy Ratio).
2) The priority of the transport block to be transmitted.
3) Content of HARQ feedback: For example, ACK, NACK or DTX.)
4) The PDB or the remaining PDB of the transport block to be transmitted.

By performing operation i), an optimal method can be employed based on the communication environment, the quality required for the transmission target, and the like.

### Operation j)

The terminal 20 may determine which of operation a) to operation i) is to be performed for each UE capability of the terminal 20.

### Operation k)

The terminal 20 may determine which of operation a) to operation i) is to be performed based on the implementation of the terminal 20.

The above-described embodiments may be applied to an operation in which one terminal 20 configures or allocates transmission resources for other terminals 20.

The above-described embodiments are not limited to V2X terminals, but may be applied to terminals that perform D2D communication.

The operations according to the above-described embodiments may be performed only in a particular resource pool. For example, the operations according to the above-described embodiments may be performed only with respect to resource pools that can be used by the terminal 20 according to release 17 or later.

According to the above-described embodiments, the terminal 20 can appropriately control the operations related to resource selection based on the situation of sensing. Also, the terminal 20 can clarify the operations related to sensing and resource selection in above condition 1) to above condition 4). Also, the terminal 20 can find a good balance between avoiding resource collisions and saving power consumption.

That is, in direct terminal-to-terminal communication, resource selection can be performed based on the situation of sensing.

### (Device Configuration)

Next, a functional configuration example of the base station 10 and the terminal 20 for performing the processes and operations described above will be described. The base station 10 and the terminal 20 include functions for implementing the embodiments described above. However, each of the base stations 10 and the terminal 20 may include only some of the functions in the embodiments.

### <Base Station 10>

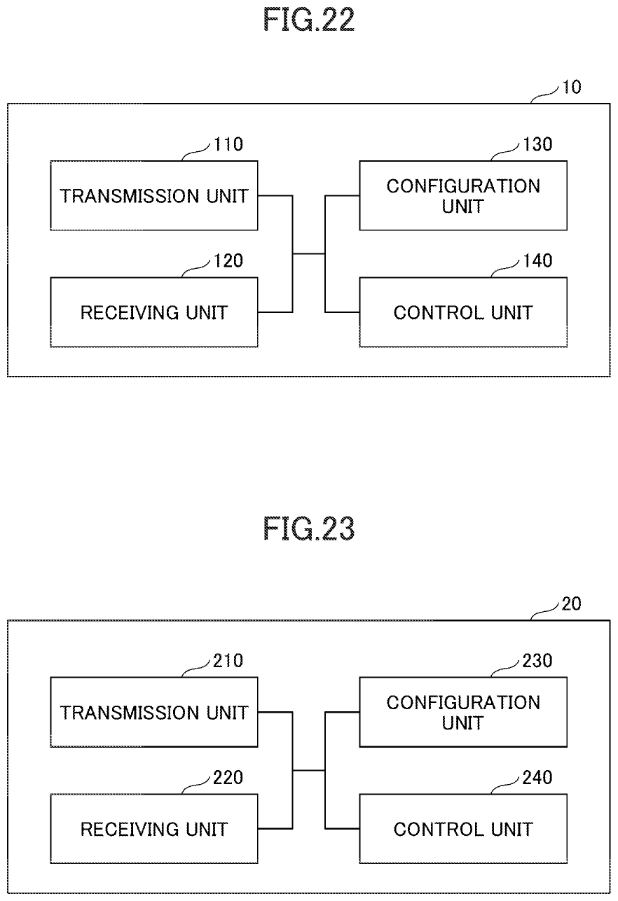

FIG. 22 is a diagram illustrating an example of a functional configuration of the base station 10. As illustrated in FIG. 22, the base station 10 includes a transmission unit 110, a receiving unit 120, a configuration unit 130, and a control unit 140. The functional configuration illustrated in FIG. 22 is only one example. A functional category and the name of the functional unit may be any category or name insofar as the functional unit can perform the operations according to the embodiments of the present invention.

The transmission unit 110 includes a function for generating a signal to be transmitted to the terminal 20 side and transmitting the signal wirelessly. The receiving unit 120 includes a function for receiving various signals transmitted from the terminal 20 and acquiring, for example, information related to a higher layer from the received signals. Also, the transmission unit 110 has a function for transmitting NR-PSS, NR-SSS, NR-PBCH, DL/UL control signals, DL reference signals, and the like to the terminal 20.

The configuration unit 130 stores preset configuration information and various configuration information to be transmitted to the terminal 20 in the storage device and reads the preset configuration information from the storage device if necessary. The contents of the configuration information are, for example, information related to the configuration of D2D communication.

As described in the embodiments, the control unit 140 performs processes related to the configuration for allowing the terminal 20 to perform D2D communication. Also, the control unit 140 transmits the scheduling of D2D communication and DL communication to the terminal 20 through the transmission unit 110. The control unit 140 receives information related to the HARQ response of the D2D communication and the DL communication from the terminal 20 via the receiving unit 120. A functional unit related to signal transmission in the control unit 140 may be included in the transmission unit 110, and a functional unit related to signal reception in the control unit 140 may be included in the receiving unit 120.

### <Terminal 20>

FIG. 23 is a diagram illustrating an example of a functional configuration of the terminal 20. As illustrated in FIG. 23, the terminal 20 includes a transmission unit 210, a receiving unit 220, a configuration unit 230, and a control unit 240. The functional configuration illustrated in FIG. 23 is only one example. A functional category and the name of the functional unit may be any category or name insofar as the functional unit can perform the operations according to the embodiments of the present invention.

The transmission unit 210 generates a transmission signal from the transmission data and wirelessly transmits the transmission signal. The receiving unit 220 receives various signals wirelessly and acquires higher layers signals from the received signals of the physical layer. The receiving unit 220 has a function to receive NR-PSS, NR-SSS, NR-PBCH, DL/UL/SL control signals or reference signals transmitted from the base station 10. For example, the transmission unit 210 transmits PSCCH (Physical Sidelink Control CHannel), PSSCH (Physical Sidelink Shared CHannel), PSDCH (Physical Sidelink Discovery CHannel), PSBCH (Physical Sidelink Broadcast CHannel), and the like to the other terminal 20 as D2D communication, and the receiving unit 220 receives PSCCH, PSSCH, PSDCH, PSBCH, and the like from other terminals 20.

The configuration unit 230 stores various configuration information received from the base station 10 or the terminal 20 via the receiving unit 220 in the storage device and reads the received configuration information from the storage device as necessary. The configuration unit 230 also stores the preset configuration information. The contents of the configuration information are, for example, information related to the configuration of D2D communication.

As described in the embodiments, the control unit 240 controls D2D communication to establish RRC connections with other terminals 20. The control unit 240 performs processes related to the power saving operation. The control unit 240 performs HARQ-related processes in D2D communication and DL communication. The control unit 240 transmits, to the base station 10, information related to HARQ response in D2D communication and DL communication to other terminals 20 scheduled by the base station 10. The control unit 240 may schedule D2D communication for other terminals 20. The control unit 240 may select resources for used D2D communication autonomously from the resource selection window based on the sensing result, or may perform reevaluation or preemption. The control unit 240 performs processes related to power saving in transmission and reception in D2D communication. The control unit 240 performs processes related to terminal-to-terminal coordination in D2D communication. A functional unit related to signal transmission in the control unit 240 may be included in the transmission unit 210, and a functional unit related to signal reception in the control unit 240 may be included in the receiving unit 220.

### (Hardware Configuration)

The block diagrams (FIG. 22 and FIG. 23) used for the description of the above embodiments illustrate blocks of functional units. These functional blocks (components) are implemented by any combination of at least one of hardware and software. In addition, the implementation method of each functional block is not particularly limited. That is, each functional block may be implemented using a single device that is physically or logically combined, or may be implemented by directly or indirectly connecting two or more devices that are physically or logically separated (for example, using wire, radio, etc.) and using these multiple devices. The functional block may be implemented by combining software with the above-described one device or the above-described plurality of devices.

Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, and the like. For example, a functional block (component) that functions to transmit is called a transmitting unit or a transmitter. In either case, as described above, the implementation method is not particularly limited.

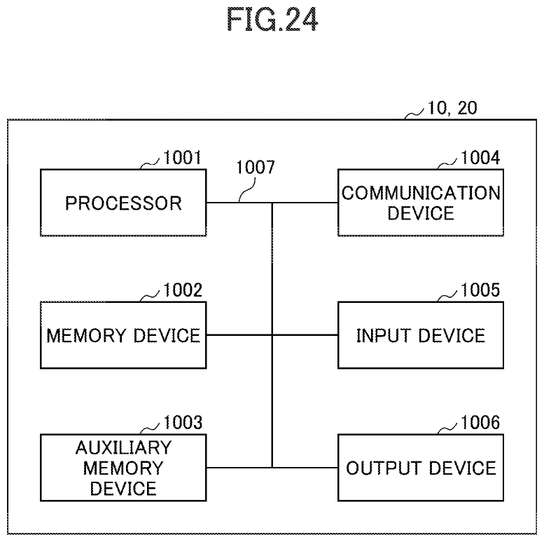

For example, the base station 10, the terminal 20, or the like in an embodiment of the present disclosure may function as a computer for performing a process of the radio communication method according to the present disclosure. FIG. 24 is a diagram illustrating an example of a hardware configuration of the base station 10 and the terminal 20 according to an embodiment of the present disclosure. Each of the base station 10 and the terminal 20 described above may be physically configured as a computer device including a processor 1001, a storage device 1002, an auxiliary storage device a 1003, communication device 1004, an input device 1005, an output device 1006, a bus 1007, and the like.

In the following description, the term “device” can be replaced with a circuit, device, unit, or the like. The hardware configuration of each of the base station 10 and the terminal 20 may be configured to include each device depicted, or may be configured without including some devices.

Each function in each of the base station 10 and the terminal 20 is implemented such that predetermined software (program) is read on hardware, such as the processor 1001, the storage device 1002, and the like, and the processor 1001 performs an operation and controls communication by the communication device 1004 and at least one of reading and writing of data in the storage device 1002 and the auxiliary storage device 1003.

For example, the processor 1001 operates an operating system and controls the entire computer. The processor 1001 may be configured with a Central Processing Unit (CPU) including an interface with a peripheral device, a control device, an operation device, a register, and the like. For example, the above-described control unit 140, the control unit 240, and the like may be implemented by the processor 1001.

Furthermore, the processor 1001 reads a program (program code), a software module, data, or the like from at least one of the auxiliary storage device 1003 and the communication device 1004 out to the storage device 1002, and executes various types of processes according to them. A program causing a computer to execute at least some of the operations described in the above embodiments is used as the program. For example, the control unit 140 of the base station 10 illustrated in FIG. 22 may be implemented by a control program which is stored in the storage device 1002 and operates on the processor 1001. Furthermore, for example, the control unit 240 of the terminal 20 illustrated in FIG. 23 may be implemented by a control program which is stored in the storage device 1002 and operates on the processor 1001. Various types of processes are described to be executed by one processor 1001 but may be executed simultaneously or sequentially by two or more processors 1001. The processor 1001 may be implemented by one or more chips. The program may be transmitted from a network via an electric communication line.

The storage device 1002 is a computer readable recording medium and may be configured with, for example, at least one of a Read Only Memory (ROM), an Erasable Programmable ROM (EPROM), an Electrically Erasable Programmable ROM (EEPROM), a Random Access Memory (RAM), and the like. The storage device 1002 may also be referred to as a “register”, a “cache”, a “main memory”, or the like. The storage device 1002 can store programs (program codes), software modules, or the like which are executable for carrying out the communication method according to an embodiment of the present disclosure.

The auxiliary storage device 1003 is a computer-readable recording medium and may be configured with, for example, at least one of an optical disk such as a Compact Disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The above-described storage medium may be, for example, a database, a server, or any other appropriate medium including at least one of the storage device 1002 and the auxiliary storage device 1003.

The communication device 1004 is hardware (a transmitting and receiving device) for performing communication between computers via at least one of a wired network and a wireless network and is also referred to as, for example, a “network device”, a “network controller”, a “network card”, a “communication module”, or the like. The communication device 1004 may be configured to include a high frequency switch, a duplexer, a filter, a frequency synthesizer, and the like to implement at least one of frequency division duplex (FDD: Frequency Division Duplex) and time division duplex (TDD: Time Division Duplex). For example, transmitting and receiving antennas, an amplifier, a transceiver, a transmission line interface, and the like may be implemented by the communication device 1004. The transceiver may be implemented such that a transmitter and a receiver are physically or logically separated.

The input device 1005 is an input device configured to receive an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integrally formed (such as a touch panel).

The devices, such as the processor 1001 and the storage device 1002, are connected by the bus 1007 for communicating information. The bus 1007 may be configured with a single bus or may be configured with different buses between the devices.

Furthermore, each of the base station 10 and the terminal 20 may be configured to include hardware, such as a microprocessor, a digital signal processor (DSP: Digital Signal Processor), an Application Specific Integrated Circuit (ASIC), a Programmable Logic Device (PLD), or a Field Programmable Gate Array (FPGA), or all or some of the functional blocks may be implemented by the hardware. For example, the processor 1001 may be implemented by at least one of these hardware components.

### Summary of Embodiments

As described above, according to an embodiment of the present invention, a terminal is provided. The terminal includes: a receiving unit configured to receive a signal from another terminal in a resource pool in which partial sensing is configured and periodic reservation is enabled; a control unit configured to determine candidate resources for resource selection in the resource pool from a resource selection window, determine resources that correspond to the candidate resources and are sensing targets, and select resources that are available for use by identifying the candidate resources based on a sensing result of the resources that are sensing targets; and a transmission unit configured to perform transmission to the other terminal by using the selected resources. In a case where not all of the resources that are sensing targets can be monitored, the control unit performs a resource selection-related operation that is different from a resource selection-related operation that is performed in a case where all of the resources that are sensing targets can be monitored.

With the above configuration, the terminal 20 can appropriately control the resource selection-related operation based on the situation of sensing. Also, the terminal 20 can clarify the sensing and resource selection-related operations according to above condition 1) to above condition 4). Also, the terminal 20 can find a good balance between avoiding resource collisions and saving power consumption. That is, the terminal 20 can perform resource selection based on the situation of sensing in direct terminal-to-terminal communication.

In a case where at least a part of the resources that are sensing targets is included in a DRX inactive time, the control unit may perform a resource selection-related operation that is different from the resource selection-related operation that is performed in a case where all of the resources that are sensing targets can be monitored. With this configuration, the terminal 20 can appropriately control the resource selection-related operation based on the situation of sensing. Also, the terminal 20 can clarify the sensing and resource selection-related operations according to above condition 1).

In a case where not all of the resources that are sensing targets can be monitored, the control unit may perform sensing targeting aperiodic reservation, without performing sensing targeting periodic reservation. With this configuration, the terminal 20 can appropriately control the resource selection-related operation based on the situation of sensing.

In a case where not all of the resources that are sensing targets can be monitored, the control unit may perform random selection without identifying the resources. With this configuration, the terminal 20 can appropriately control the resource selection-related operation based on the situation of sensing.

In a case where not all of the resources that are sensing targets can be monitored, the control unit need not perform resource selection until all of the resources that are sensing targets that correspond to the candidate resources that updated are monitored. With this configuration, the terminal 20 can appropriately control the operation related to resource selection based on the situation of sensing.

Furthermore, according to an embodiment of the present invention, a communication method is provided. The communication method includes: receiving a signal from another terminal in a resource pool in which partial sensing is configured and periodic reservation is enabled; determining resources to be candidates for resource selection in the resource pool from a resource selection window, determining resources that correspond to the candidate resources and are sensing targets, and selecting resources that are available for use by identifying the candidate resources based on a sensing result of the resources that are sensing targets; and performing transmission to the other terminal by using the selected resources. In this communication method, in a case where not all of the resources that are sensing targets can be monitored, a resource selection-related operation that is different from a resource selection-related operation that is performed in a case where all of the resources that are sensing targets can be monitored is performed.

With the above configuration, the terminal 20 can appropriately control the resource selection-related operation based on the situation of sensing. Also, the terminal 20 can clarify the sensing and resource selection-operations according to above condition 1) and above condition 4). Also, the terminal 20 can find a good balance between avoiding resource collisions and saving power consumption. That is, the terminal 20 can perform resource selection appropriately based on the situation of sensing in direct terminal-to-terminal communication.

### Notes on Embodiments

Embodiments of the present invention have been described above, but the disclosed invention is not limited to the above embodiments, and those skilled in the art would understand various modified examples, revised examples, alternative examples, substitution examples, and the like. In order to facilitate understanding of the invention, specific numerical value examples have been used for description, but the numerical values are merely examples, and certain suitable values may be used unless otherwise stated. The classification of items in the above description is not essential to the present invention. Matters described in two or more items may be combined and used if necessary, and a matter described in one item may be applied to a matter described in another item (as long as there is no contradiction). The boundary between functional units or processing units in a functional block diagram does not necessarily correspond to the boundary between physical parts. Operations of a plurality of functional units may be performed physically by one component, or an operation of one functional unit may be physically performed by a plurality of parts. In the processing procedure described in the embodiments, the order of the processes may be changed as long as there is no contradiction. For the sake of convenience of processing description, the base station 10 and the terminal 20 are described using the functional block diagrams, but such devices may be implemented by hardware, software, or a combination thereof. Software executed by the processor included in the base station 10 according to the embodiments of the invention and software executed by the present processor included in the terminal 20 according to the embodiments of the present invention may be stored in a RAM (Random Access Memory), a flash memory, a ROM (Read-Only Memory), an EPROM, an EEPROM, a register, an HDD (Hard Disk Drive), a removable disk, a CD-ROM, a database, a server, or any other appropriate storage medium.

Furthermore, notification of information is not limited to the aspects or embodiments described in the present disclosure and may be provided by using any other method. For example, the notification of information may be provided by physical layer signaling (for example, DCI (Downlink Control Information) or UCI (Uplink Control Information)), higher layer signaling (for example, RRC (Radio Resource Control) signaling, MAC (Medium Access Control) signaling, broadcast information (MIB (Master Information Block), SIB (System Information Block), etc.), other signals, or a combination thereof. Furthermore, RRC signaling may be referred to as an RRC message and may be, for example, an RRC connection setup message, an RRC connection reconfiguration message, or the like.

Each aspect and embodiment described in the present disclosure may be applied to at least one of LTE (Long Term Evolution), LTE-A (LTE-Advanced), SUPER 3G, IMT-Advanced, 4G (4th Generation mobile communication system), 5G (5th Generation mobile communication system), FRA (Future Radio Access), NR (New Radio), W-CDMA (registered trademark), GSM (registered trademark), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), a system using any other appropriate system, and next generation systems extended based on these standards. Furthermore, a plurality of systems (for example, a combination of at least one of LTE and LTE-A with 5G) may be combined to be applied.

The order of the processing procedures, the order of the sequences, the order of the flowcharts, and the like of the respective aspects/embodiments described in this specification may be changed, provided that there is no contradiction. For example, the method described in the present disclosure presents elements of various steps with an exemplary order and is not limited to a presented specific order.

In this specification, a specific operation to be performed by the base station 10 may be performed by an upper node in some cases. In the network including one or more network nodes including the base station 10, various operations performed for communication with the terminal 20 can be obviously performed by at least one of the base station 10 and any network node (for example, an MME, an S-GW, or the like is considered, but it is not limited thereto) other than the base station 10. A case is exemplified above in which there is one network node other than the base station 10. The one network node may be a combination of a plurality of other network nodes (for example, MME and S-GW).

Information, a signal, or the like described in the present disclosure may be output from a higher layer (or a lower layer) to a lower layer (or a higher layer). Information, a signal, or the like described in the present disclosure may be input and output via a plurality of network nodes.

Input and output information and the like may be stored in a specific place (for example, a memory) or may be managed by using a management table. Input and output information and the like may be overwritten, updated, or additionally written. Output information and the like may be deleted. Input information and the like may be transmitted to another device.

The determination in the present disclosure may be made in accordance with a value (0 or 1) indicated by one bit, may be made in accordance with a Boolean value (Boolean: true or false), or may be made by a comparison of numerical values (for example, a comparison with a predetermined value).

Software should be broadly interpreted to mean a command, a command set, a code, a code segment, a program code, a program, a subprogram, a software module, an application, a software application, a software package, a routine, a subroutine, an object, an executable file, an execution thread, a procedure, a function, and the like, regardless of whether software is called software, firmware, middleware, a microcode, a hardware description language, or any other name.

Furthermore, software, commands, information, and the like may be transmitted and received via a transmission medium. For example, when software is transmitted from a web site, a server, or any other remote source using a wired technology (such as a coaxial cable, a fiber optic cable, a twisted pair, or a DSL (Digital Subscriber Line)) and a radio technology (such as infrared rays or a microwave), at least one of these wired technology and radio technology is included in a definition of a transmission medium.

Information, signals, and the like described in the present disclosure may be expressed using any one of a variety of different techniques. For example, data, instructions, commands, information, signals, bits, symbols, chips, and the like which are mentioned throughout the above description may be expressed by voltages, currents, electromagnetic waves, magnetic fields or magnetic particles, optical fields or photons, or any combination thereof.

The terms described in the present disclosure and terms necessary for understanding the present disclosure may be replaced with terms having the same or similar meanings. For example, at least one of a channel and a symbol may be a signal (signaling). Furthermore, a signal may be a message. Furthermore, a component carrier (CC: Component Carrier) may be referred to as a “carrier frequency”, a “cell”, a “frequency carrier”, or the like.

The terms “system” and “network” used in the present disclosure are used interchangeably.

Furthermore, information, parameters, and the like described in the present disclosure may be expressed by using absolute values, may be expressed by using relative values from predetermined values, or may be expressed by using any other corresponding information. For example, radio resources may be those indicated by an index.

The names used for the above-described parameters are not limited names in any point of view. Furthermore, mathematical formulas or the like using the parameters may be different from those explicitly disclosed in the present disclosure. Since various channels (for example, a PUSCH, a PUCCH, a PDCCH, etc.) and information elements can be identified by any suitable names, various names assigned to the various channels and the information elements are not limited names in any point of view.

In the present disclosure, the terms “base station (BS: Base Station)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to by a term such as a macrocell, a small cell, a femtocell, and a picocell.

The base station can accommodate one or more (for example, three) cells. In a case in which the base station accommodates a plurality of cells, the entire coverage area of the base station can be partitioned into a plurality of small areas, and each small area can provide a communication service through a base station subsystem (for example, a small indoor base station (RRH: Remote Radio Head)). The term “cell” or “sector” refers to the whole or a part of the coverage area of at least one of the base station and the base station subsystem a that performs communication service in the coverage.

In the present disclosure, the terms “mobile station (MS: Mobile Station)”, “user terminal”, “user equipment (UE)”, “terminal”, and the like can be used interchangeably.

The mobile station may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

At least one of the base station and the mobile station may be also referred to as a transmission device, a reception device, a communication device, or the like. At least one of the base station and the mobile station may be a device installed in a mobile body, a mobile body itself, or the like. The mobile body may be a vehicle (for example, a car, an airplane, etc.), an unmanned body that moves (for example, a drone, an autonomous car or the like), or a robot (manned type or unmanned type). At least one of the base station and the mobile station includes a device that need not move during a communication operation. For example, at least one of the base station and the mobile station may be an Internet of Things (IOT) device such as a sensor.

Furthermore, the base station in the present disclosure may be replaced by the user terminal. For example, various aspects/embodiments of the present disclosure may be applied for a configuration in which communication between the base station and the user terminal is replaced by communication between multiple terminals 20 (such communication may be referred to as D2D (Device-to-Device), V2X (Vehicle-to-Everything), etc.). In this case, the terminals 20 may have the functions provided by the base station 10 described above. The phrases “uplink” and “downlink” may also be replaced by the phrases corresponding to terminal-to-terminal communication (for example, “side”). For example, an uplink channel, a downlink channel, or the like may be replaced by a side channel.

Similarly, the user terminal in the present disclosure may be replaced with the base station. In this case, the base station may have the functions of the above-described user terminal.

The terms “determination (determining)” and “decision (determining)” used in the present specification may include various types of operations. The “determination” and “decision” may include deeming “judging”, “calculating”, “computing”, “processing”, “deriving”, “investigating”, “looking up/search/inquiry (for example, searching in a table, a database, or another data structure)”, “searching”, “inquiring”, or “ascertaining” as “determining” and/or “deciding”. Furthermore, the “determination” and “decision” may include deeming “receiving (for example, receiving information)”, “transmitting (for example, transmitting information)”, “inputting”, “outputting”, or “accessing (for example, accessing data in a memory)” as “determining” and/or “deciding”. Furthermore, the “determination” and “decision” may include deeming “resolving”, “selecting”, “choosing”, “establishing”, or “comparing” as “determining” and/or “deciding”. Namely, the “determination” and “decision” may include deeming an operation as “determining” and/or “deciding”. Furthermore, “determining” may be replaced with “assuming”, “expecting”, “considering”, or the like.

Terms “connected”, “coupled”, or variations thereof means any direct or indirect connection or coupling between two or more elements and may include the presence of one or more intermediate elements between two elements which are “connected” or “coupled”. The coupling or the connection between the elements may be physical, logical, or a combination thereof. For example, “connection” may be replaced with “access”. In a case of using in the present disclosure, two elements may be considered to be “connected” or “coupled” with each other using at least one of one or more electric wires, cables and/or a printed electrical connection or using electromagnetic energy having a wavelength in a radio frequency domain, a microwave region, or a light (both visible and invisible) region as non-limiting and non-exhaustive examples.

A reference signal may be abbreviated as RS (Reference Signal) and may be referred to as a pilot, depending on a standard to be applied.

A phrase “based on” used in the present disclosure is not limited to “based only on” unless otherwise stated. In other words, a phrase “based on” means both “based only on” and “based on at least”.

Any reference to an element using a designation, such as “first” or “second”, used in the present disclosure does not generally restrict quantities or an order of those elements. Such designations can be used in the present disclosure as a convenient method of distinguishing elements. Thus, reference to the first and second elements does not mean that only two elements can be adopted there, or the first element must precede the second element in a certain form.

Furthermore, “means” in the configuration of each of the above devices may be replaced with “unit”, “circuit”, “device”, or the like.

When “include”, “including”, and variations thereof are used in the present disclosure, these terms are intended to be comprehensive, similar to a term “provided with (comprising)”. Furthermore, the term “or” used in the present disclosure is intended not to be an exclusive OR.

A radio frame may include one or more frames in the time domain. In the time domain, each of one or more frames may be referred to as a subframe. The subframe may further include one or more slots in the time domain. The subframe may have a fixed time length (for example, 1 ms) not depending on numerology.

The numerology may be a communication parameter applied to at least one of transmission and reception of a certain signal or channel. For example, the numerology may indicate at least one of a subcarrier spacing (SCS: SubCarrier Spacing), a bandwidth, a symbol length, a cyclic prefix length, a transmission time interval (TTI: Transmission Time Interval), a number of symbols per TTI, a radio frame configuration, a specific filtering process performed in the frequency domain by a transceiver, a specific windowing process performed in the time domain by a transceiver, and the like.

The slot may include one or more symbols (OFDM (Orthogonal Frequency Division Multiplexing) symbols, SC-FDMA (Single Carrier Frequency Division Multiple Access) symbols, etc.) in the time domain. The slot may be a time unit based on the numerology.

The slot may include a plurality of mini slots. Each mini slot may include one or more symbols in the time domain. Furthermore, the mini slot may be referred to as a sub-slot. The mini slot may include fewer symbols than a slot. A PDSCH (or PUSCH) transmitted in a unit of time greater than a mini slot may be referred to as a PDSCH (or PUSCH) mapping type A. A PDSCH (or PUSCH) transmitted using a mini slot may be referred to as a PDSCH (or PUSCH) mapping type B.

Any one of a radio frame, a subframe, a slot, a mini slot, and a symbol indicates a time unit for transmitting a signal. As a radio frame, a subframe, a slot, a mini slot, and a symbol, different names corresponding to them may be used.

For example, one subframe may be referred to as a transmission time interval (TTI: Transmission Time Interval), or a plurality of consecutive subframes may be referred to as TTIs, or one slot or one mini slot may be referred to as a TTI. In other words, at least one of the subframe and the TTI may be a subframe (1 ms) in existing LTE, may be a period shorter than 1 ms (for example, 1 to 13 symbols), or may be a period longer than 1 ms. A unit representing the TTI may be referred to as a slot, a mini slot, or the like, instead of the subframe.

Here, for example, the TTI refers to a minimum time unit of scheduling in wireless communication. For example, in the LTE system, the base station performs scheduling of allocating a radio resource (a frequency bandwidth, a transmission power, or the like which can be used in each terminal 20) to each terminal 20 in units of TTIs. The definition of the TTI is not limited thereto.

The TTI may be a transmission time unit such as a channel-coded data packet (transport block), a code block, or a codeword, or may be a processing unit of, for example, scheduling or link adaptation. Furthermore, when a TTI is provided, a time interval (for example, the number of symbols) in which a transport block, a code block, a codeword, or the like is actually mapped may be shorter than the TTI.

When one slot or one mini slot is referred to as a TTI, one or more TTIs (that is, one or more slots or one or more mini slots) may be a minimum time unit of scheduling. Furthermore, the number of slots (the number of mini slots) forming the minimum time unit of scheduling may be controlled.

A TTI having a time length of 1 ms may be referred to as a common TTI (TTI in LTE Rel. 8 to 12), a normal TTI, a long TTI, a common subframe, a normal subframe, a long subframe, a slot, or the like. A TTI shorter than the common TTI may be referred to as a reduced TTI, a short TTI, a partial TTI (a partial or fractional TTI), a reduced subframe, a short subframe, a mini slot, a sub slot, a slot, or the like.

Furthermore, a long TTI (for example, a normal TTI, a subframe, etc.) may be replaced with a TTI having a time length exceeding 1 ms, and a short TTI (for example, a reduced TTI or the like) may be replaced with a TTI having a TTI length that is shorter than a TTI length of a long TTI and that is longer than or equal to 1 ms.

The resource block (RB) is a resource allocation unit in the time domain and the frequency domain, and may include one or more consecutive subcarriers in the frequency domain. The number of subcarriers included in an RB may be the same, irrespective of a numerology and may be, for example, 12. The number of subcarriers included in an RB may be determined based on a numerology.

Furthermore, a time field of an RB may include one or more symbols and may be a length of one slot, one mini slot, one subframe, or one TTI. One TTI, one subframe, or the like may be formed of one or more resource blocks.

Furthermore, one or more RBs may be referred to as a physical resource block (PRB: Physical RB), a subcarrier group (SCG: SubCarrier Group), a resource element group (REG: Resource Element Group), a PRB pair, an RB pair, or the like.

Furthermore, the resource block may be formed of one or more resource elements (RE: Resource Element). For example, one RE may be a radio resource field of one subcarrier and one symbol.

A bandwidth part (BWP: Bandwidth Part) (which may be referred to as a partial bandwidth or the like) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include BWP for UL (UL BWP) and BWP for DL (DL BWP). In the terminal 20, one or more BWPs may be configured in one carrier.

At least one of configured BWPs may be active, and the UE need not assume that predetermined signals/channels are transmitted and received outside an active BWP. Furthermore, a “cell”, a “carrier”, or the like in the present disclosure may be replaced with a “BWP”.

Structures of the radio frame, the subframe, slot, the mini slot, and the symbol are merely examples. For example, configurations such as the number of subframes included in a radio frame, the number of slots per frame, the number of mini slots included in a slot, the number of symbols and RBs included in a slot or a mini slot, the number of subcarriers included in an RB, the number of symbols in a TTI, a symbol length, a cyclic prefix (CP: Cyclic Prefix) length, and the like can be variously changed.

In the present disclosure, for example, when an article such as “a”, “an”, or “the” in English is added by a translation, the present disclosure may include a case in which a noun following the article is the plural.

In the present disclosure, the term “A and B are different” may mean “A and B are different from each other”. Incidentally, the term may mean “A and B are different from C”. Terms such as “separated” or “combined” may be interpreted as well as “different”.

Each aspect/embodiment described in the present disclosure may be used alone, in combination, or may be switched in accordance with the execution. Furthermore, notification of predetermined information (for example, notification of “being X”) is not limited to notification performed explicitly, but may be performed implicitly (for example, not notifying the predetermined information).

Although the present disclosure is described above in detail, it is obvious to those skilled in the art that the present disclosure is not limited to the embodiments described in the present disclosure. The present disclosure may be implemented as revised and modified embodiments without departing from the gist and scope of the present disclosure as set forth in claims. Accordingly, the description of the present disclosure is for the purpose of illustration and does not have any restrictive meaning to the present disclosure.

The present international patent application is based on and claims priority to Japanese patent application No. 2021-070674, filed on Apr. 19, 2021, the entire contents of which are hereby incorporated herein by reference.

### DESCRIPTION OF THE REFERENCE NUMERALS

10 Base station
110 Transmission unit
120 Receiving unit
130 Configuration unit
140 Control unit
20 Terminal
210 Transmission unit
220 Receiving unit
230 Configuration unit
240 Control unit
1001 Processor
1002 Storage device
1003 Auxiliary storage device
1004 Communication device
1005 Input device
1006 Output device

1. A terminal comprising:
a receiving unit configured to receive a signal from another terminal in a resource pool in which partial sensing is configured and periodic reservation is enabled;
a control unit configured to determine candidate resources for resource selection in the resource pool from a resource selection window, determine resources that correspond to the candidate resources and are sensing targets, and select resources that are available for use by identifying the candidate resources based on a sensing result of the resources that are sensing targets; and
a transmission unit configured to perform transmission to the other terminal by using the selected resources,
wherein, in a case where not all of the resources that are sensing targets can be monitored, the control unit performs a resource selection-related operation that is different from a resource selection-related operation that is performed in a case where all of the resources that are sensing targets can be monitored.

2. The terminal according to claim 1, wherein, in a case where at least a part of the resources that are sensing targets is included in a DRX inactive time, the control unit performs the resource selection-related operation that is different from the resource selection-related operation that is performed in a case where all of the resources that are sensing targets can be monitored.

3. The terminal according to claim 1, wherein, in a case where not all of the resources that are sensing targets can be monitored, the control unit performs sensing targeting aperiodic reservation, without performing sensing targeting periodic reservation.

4. The terminal according to claim 1, wherein, in a case where not all of the resources that are sensing targets can be monitored, the control unit performs random selection without identifying resources.

5. The terminal according to claim 1, wherein, in a case where not all of the resources that are sensing targets can be monitored, the control unit does not perform resource selection until all of the resources that are sensing targets that correspond to the candidate resources that are updated are monitored.

6. A communication method comprising:
receiving a signal from another terminal in a resource pool in which partial sensing is configured and periodic reservation is enabled;
determining candidate resources for resource selection in the resource pool from a resource selection window, determining resources that correspond to the candidate resources and are sensing targets, and selecting resources that are available for use by identifying the candidate resources based on a sensing result of the resources that are sensing targets; and
performing transmission to the other terminal by using the selected resources,
wherein, in a case where not all of the resources that are sensing targets can be monitored, performing a resource selection-related operation that is different from a resource selection-related operation that is performed in a case where all of the resources that are sensing targets can be monitored.
